(19) United States
(12) Patent Application Publication
(10) Pub. No.: US 2004/0073648 A1
(43) Pub. Date: Apr. 15, 2004

(54) Network calculator system and management device

(75) Inventors: Shingo Tanino, Kawasaki (JP); Sawao Iwatani, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Fujitsu Limited, Kawasaki (JP)

(21) Appl. No.: 10/644,000

(22) Filed: Aug. 20, 2003

(30) Foreign Application Priority Data
Aug. 28, 2002 (JP) 2002-248595

(51) Int. Cl. G06F 15/173

(52) U.S. Cl. 709/223

(57) ABSTRACT

A management device creates transmission path connection information from device information which it collects from individual devices. If the management device is notified of a faulty device from a managed device, it identify a transmission path containing the faulty device and causes the server, which accesses data stored in the storage through the transmission path, to stop using the transmission path. To deal with devices not having the failure notice function, the management device can cause individual devices to present device information on a regular basis and detect a faulty device from the received device information. When the transmission path is restored to proper working condition, the management device is notified of the restored path and automatically causes to the server to start using that transmission path. Note that the functions performed by the management device can also be provided as programs.

### BACKGROUND OF THE INVENTION

1. Field of the Invention

The present invention relates to a network calculator system, in which individual devices are connected to one another through a network, comprising a plurality of transmission lines for access between the devices, and to a management device connected to the network.

2. Description of the Related Arts

For a network calculator system in which a server accesses a storage for exchanging data with the storage and in which a server exchanges data with clients connected through a network, it is necessary not to stop services.

Therefore, one of the methods to prevent stoppage of services is to provide a plurality of transmission lines to allow the server to access data in the storage. The transmission lines consist of a server interface for connection to peripherals (Host Bus Adapter: HBA), a storage interface (Connection Module: CM), a disk or tape device and connection lines connecting them.

The server uses a plurality of transmission lines to access data in the storage. For this reason, if a transmission line cannot be used due to a failure of a device comprising that transmission line, it is possible to continue processing using other paths.

Another method to prevent stoppage of services is to prevent a failure before it takes place, detect a faulty area early, take necessary actions if a failure is detected and create an environment in which post-failure analyses and faulty area's parts replacement can be smoothly carried out. For this reason, a management device, which manages the statuses of individual devices, is introduced to the network calculator system.

For example, a program called the SNMP Manager employing SNMP (Simple Network Management Protocol) and another program called the SNMP Agent are installed respectively onto the management device and the devices to be managed (e.g., server, storage, fiber channel switch). With some devices, the SNMP Agent functionality is provided by built-in hardware.

Since the SNMP Agent allows individual devices to manage their status tables by themselves and since the SNMP Manager makes a request to the devices to be managed for status tables via the network on a regular basis, all status tables are collected by the management device and the system administrator can check devices'statuses at the I/O device connected to the management device. Moreover, the SNMP Agent has the function to notify the SNMP Manager of a failure of its own device via the network upon occurrence of that failure.

This function allows the system administrator to prevent a failure before it occurs by constantly monitoring the devices'statuses at the management device and manually stopping the faulty area if he or she detects abnormal operation. Moreover, when an occurrence of failure is confirmed, it is possible to immediately take necessary actions and reduce service stoppage time even if such stoppage time occurs.

The conventional failure response processing in a network calculator system discussed above is described using FIGS. 1 and 2. FIG. 1 illustrates an example of network calculator system configuration comprising a server, a storage and a management device. Although only a set of server and storage is shown in the network calculator system in FIG. 1, a plurality of servers and storages may comprise a network calculator system.

In FIG. 1, a server 1 processes data stored in a disk device 10 based on an application program 4 and provides processing results to an unillustrated client connected to a network 15. The server 1 uses two transmission lines, a transmission line 11 which runs up to the disk device 10 via a host bus adapter 5, a connection line 16, a connection module 8 and a connection line 18 and a transmission line 12 which runs up to the disk device 10 via a host bus adapter 6, a connection line 12, a CM 9 and a connection line 19, when executing the application program 4.

The SNMP Manager is installed onto a management device 13 while the SNMP Agent is installed onto the server 1 and a storage 7. This allows the management device 13 to be notified if a failure occurs in the server 1 or the storage 7.

FIG. 2 illustrates the conventional transmission line control processing in the network calculator system shown in FIG. 1 in the event of a failure. The first case is that in which the server 1 detects a failure during execution of the application program 4 as a result of the fact that there is no response from the transmission line containing a faulty area and stops using that transmission line.

Now, let us suppose that a failure occurs in the connection module (CM) 8 of the storage 7 (S21). The server 1 uses the transmission line 11 to access the disk device 10 for write or read operations based on the application program 4 (S22).

The server 1 detects a failure in a device comprising the transmission line 11 as a result of the fact that there is no response from the disk device 10 after having made several attempts to access the disk device 10 (S23). Since a failure is detected in Step S23, the server 1 stops using the transmission line 11 (S24). Since the server 1 also uses the transmission line 12 during execution of the application program 4, it can continue its processing even if it stops using the transmission line 11 in Step S24.

The second case illustrates that in which the management device 13 is notified of a failure by the SNMP Agent's function and the system administrator manually addresses the failure based on the failure notice. First, let us suppose that a failure occurs in the connection module (CM) 8 of the storage 7 (S21). Next, the SNMP Agent's function installed onto the storage 7 notifies the management device 13 that a failure has occurred in the connection module 8 (S25).

The management device 13 displays a failure notice on an input/output device 14 (S26). For example, the input/output device 14 warns the system administrator by displaying the faulty area in red through GUI (Graphical User Interface). Attention may also be called, for example, by leaving a warning message in the message log or sending mail to the stored mail address.

The system administrator checks the failure notice obtained in Step S26 and can confirm from GUI or message log that the transmission line which has become unavailable due to the faulty area is the transmission line 11. Then the system administrator halts the use of the transmission line 11 to prevent the server 1 from using the transmission line 11 during execution of the application program 4 (S27). Step S27 is performed, for example, by the system administrator logging into the server 1, entering the commands used for the application program 4, executing the application program 4 and removing the transmission line 11 from the available transmission line setting. Step S27 allows the server 1 to stop using the transmission line 11 when executing the application program 4 (S28).

Moreover, if the transmission line 11 is made available again (restored to normal) at the completion of parts replacement after the use of transmission line 11 has been halted in Step 24 of the first case and in Step 28 of the second case, the server 1 resumes using the transmission line 11, for example, as a result of the system administrator logging into the server 1 and commanding the application program 4 to start using the transmission line 11.

Note that the storage 7 in FIG. 1 may be comprised of a tape device in place of the disk device 10.

However, the server 1 detects an anomaly in the transmission line 11 in Step S23 of the first case in FIG. 2 as a result of the fact that there is no response from the storage 7 after having made several attempts to access the storage 7. For this reason, data processing stops for several seconds to several minutes, a period required to detect the transmission line anomaly, which has been a contributor to degradation in server processing performance.

Note also that in the second case an access to the transmission line containing the faulty area may occur as in the first case before the system administrator commands from the server 1 that the use of the transmission line be halted for reasons such as the system administrator does not notice displayed failure information, the system administrator cannot tell which transmission line should be used for execution of the application program 4 unless the server 1 is accessed even if the system administrator knows where the faulty area is and the system administrator is not in the environment where he or she can immediately access the server, as a result of which a response wait state occasionally results, thus causing degradation in server performance.

Moreover, if the transmission line is restored to proper working condition at the completion of parts replacement following Step S24 or S28, the system administrator must manually change the settings of the server which uses that transmission line, which has been extremely burdensome for the system administrator.

### SUMMARY OF THE INVENTION

It is therefore the object of the present invention to allow a server using a transmission line containing a faulty area to automatically stop using that transmission line in the event of a failure in a device comprising the transmission line in a network calculator system provided with a server and a storage connected to each other through a plurality of transmission lines and a management device and prevent degradation in server processing performance caused by the server accessing the transmission line containing the faulty area during execution of an application program. Another object of the present invention is to automatically set up the server such that the server can use the transmission line at the completion of restoration of the faulty area, thus reducing time and effort needed for restoration off the system administrator.

In order to achieve the above objects, an aspect of the present invention provides a network calculator system comprising at least one server and at least one storage, each of which is connected to a network, and a management device which manages device information on the server and the storage, wherein the server and the storage are connected by a plurality of transmission lines and each of the server and the storage has the failure notice function which notifies the management device of a faulty area within the server or the storage, wherein the management device records a correspondence between transmission lines used for accessing data in the storage and devices comprising the transmission lines, wherein the management device judges a transmission line as being unavailable if it is notified of a failure by the failure notice function and if the faulty area, of which the management device was notified, matches up with any device comprising that transmission line and wherein the server is caused to stop using the unavailable transmission line when the server accesses the storage.

In order to attain the above objects, another aspect of the present invention provides a network calculator system comprising at least one server and at least one storage, each of which is connected to a network, and a management device which manages device information on the server and the storage, wherein the server and the storage are connected by a plurality of transmission lines and each of the server and the storage has the restoration notice function which notifies the management device of restoration of the faulty device, wherein the management device records a correspondence between the transmission lines used by the server to access data in the storage and devices comprising transmission lines, judges a transmission line as being available if the management device is notified of restoration by the restoration notice function and if the device of which the management device was notified matches up with a device comprising the transmission lines and causes the server, in which the application program using the available transmission line is executed, to ensure that the application program starts using the transmission line.

According to the invention of claim 1, if the management device is notified a failure, a search is automatically made for the transmission line containing a faulty area, allowing the application program using the transmission line containing the faulty area to stop using that transmission line and thereby preventing degradation in server performance caused by accessing the transmission line containing the faulty area.

According to the invention of claim 4, when the management device is notified of restoration, a search is automatically made for the transmission line containing the restored area, allowing the application program using the transmission line containing the restored area to start using that transmission line and thereby taking part of time and effort needed for the procedure off the system administrator.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 illustrates an example of network calculator system comprising a server and a storage, connected by a plurality of transmission lines, and a management device;

FIG. 2 illustrates the conventional transmission line control processing in the event of a failure;

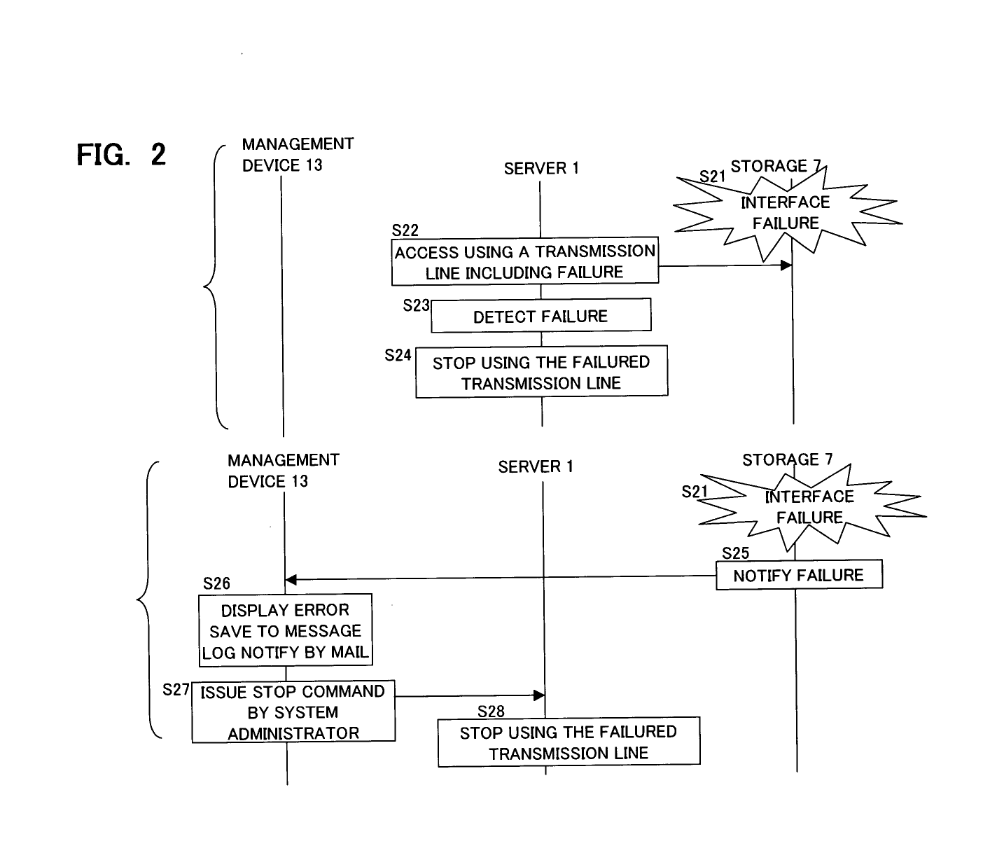

FIG. 3 illustrates an embodiment of the present invention;

FIG. 4 illustrates the functional relationship between the management device and the devices to be managed;

FIG. 5 illustrates the first transmission line control processing according to the present invention;

FIG. 6 illustrates the second transmission line control processing according to the present invention;

FIG. 7 illustrates the third transmission line control processing according to the present invention;

FIG. 8 illustrates the fourth transmission line control processing according to the present invention;

FIG. 9 illustrates an example of management device configuration;

FIG. 10 illustrates an example of server configuration;

FIG. 11 illustrates an example of storage configuration;

FIG. 12 illustrates an example of fiber channel switch configuration;

FIG. 13 illustrates another example of network calculator system configuration to which the first transmission line control processing is applied;

FIG. 14 illustrates an example of the server 21's device information;

FIG. 15 illustrates an example of the server 22's device information;

FIG. 16 illustrates an example of the server 23's device information;

FIG. 17 illustrates an example of the fiber channel switch 24's device information;

FIG. 18 illustrates an example of the fiber channel switch 25's device information;

FIG. 19 illustrates an example of the fiber channel switch 26's device information;

FIG. 20 illustrates an example of the storage 27's device information;

FIG. 21 illustrates an example of the storage 28's device information;

FIG. 22 illustrates an example of the storage 29's device information;

FIG. 23 is a flowchart for describing the transmission line connection information update processing;

FIG. 24 illustrates an example of transmission line connection information;

FIG. 25 illustrates an example in which a failure occurs in an FC switch;

FIG. 26 illustrates an example in which a failure occurs in a host bus adapter;

FIG. 27 illustrates an example in which a failure occurs in an FC switch port; and

FIG. 28 illustrates an example in which a failure occurs in a connection module.

### DESCRIPTION OF THE PREFERRED EMBODIMENTS

Embodiments of the present invention will now be described with reference to the drawings. Note, however, that the technical scope of the present invention is not limited to such embodiments the invention and extends to the invention defined in claims and to their equivalents.

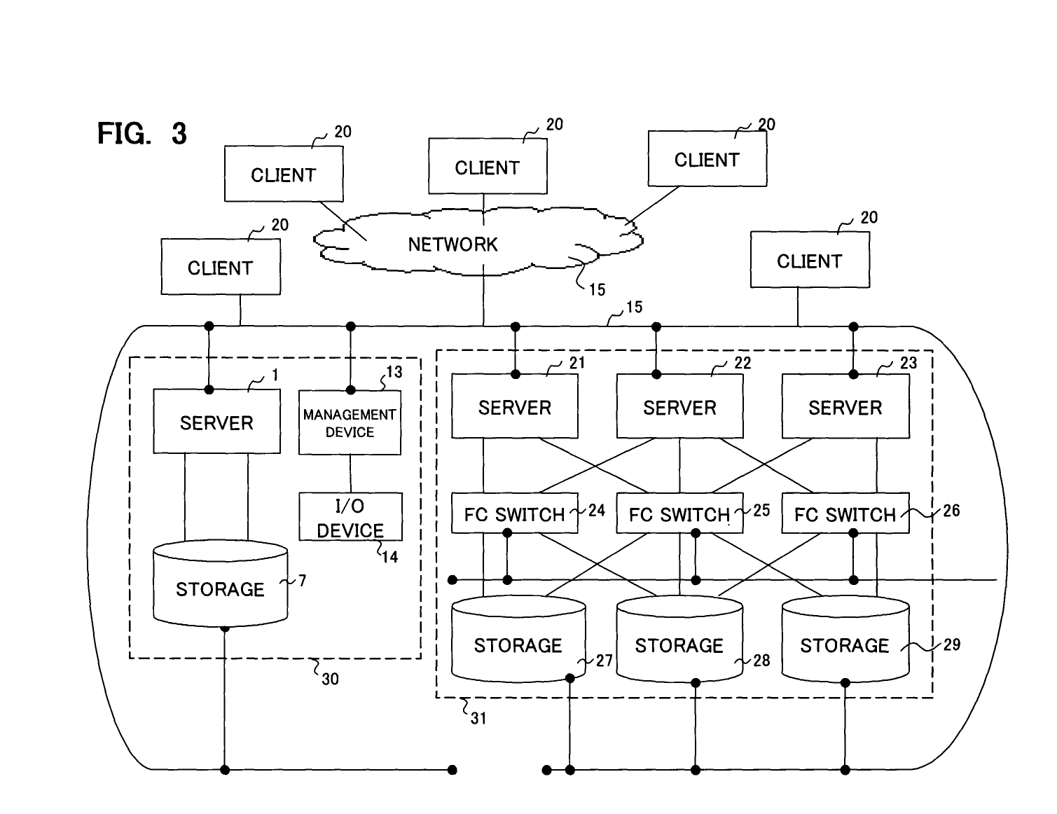

FIG. 3 shows an embodiment of the present invention. A plurality of clients 20, servers 1, 21, 22 and 23, storages 7, 27, 28 and 29 and fiber channel switches (FC switches) 24, 25 and 26 are connected to the network 15. Each of the servers processes data in its storage and provides the processing results to the clients 20. It is possible to configure the network 15 such that a fire wall is available to restrict external accesses.

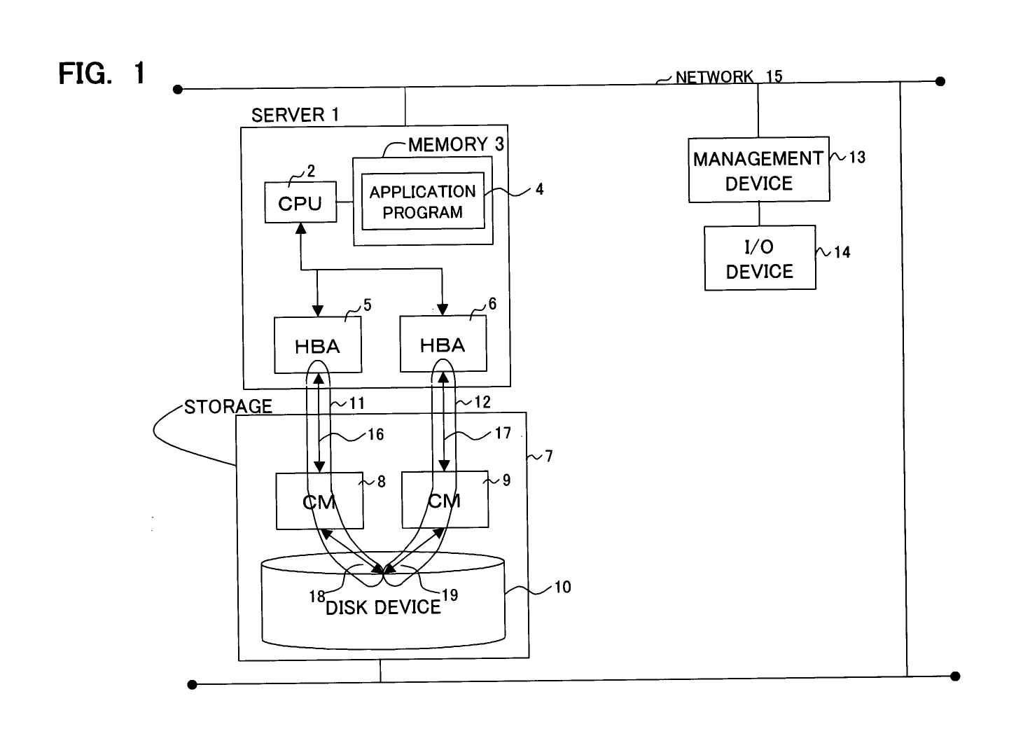

The following two embodiments are included in FIG. 3 for connecting the servers and the storages. A domain 30 shows direct connection of the server 1 to the storage 7 by a connection line. This configuration is the same as that in FIG. 1. A domain 31 illustrates a so-called SAN (Storage Area Network) configuration in which three servers or the servers 21, 22 and 23 are connected to three storages, namely, the storages 27, 28 and 29 by connection lines via three fiber channel switches or the fiber channel switches 24, 25 and 26.

In the SAN configuration, it is possible to connect servers and storages by using flexible combinations via fiber channel switches. Moreover, the SAN configuration offers advantages of efficient use of storages and high transfer rate.

The management device 13 is connected to the input/output device 14 (e.g., monitor, keyboard, mouse) as well as to the network 15. In this embodiment of the invention, the SNMP Manager is installed onto the management device 13 while the SNMP Agent is installed onto the servers 1, 21, 22 and 23, the fiber channel switches 24, 25 and 26 and the storages 27, 28 and 29.

Next, the manner in which devices such as the management device 13, the storages, the fiber channel switches or the clients in FIG. 3 function is described.

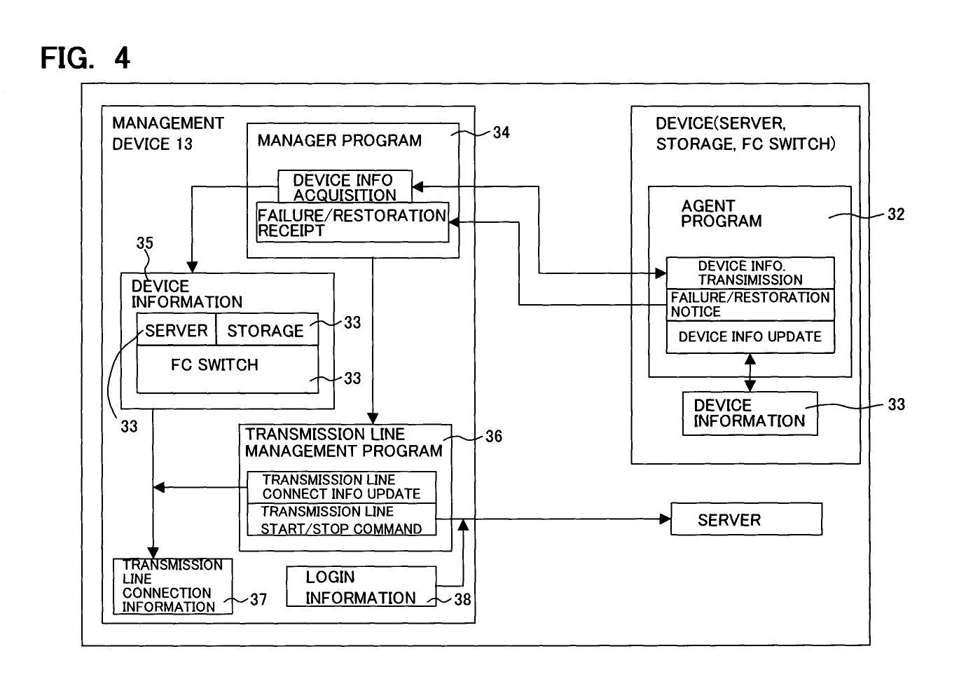

FIG. 4 shows the functional relationship between the management device and the devices to be managed such as servers, storages, fiber channel switches or clients. An agent program 32 is installed onto the devices such as servers, storages or fiber channel switches.

The agent program 32 includes the device information transmission function by which the program transmits device information via the network in response to a request from the management device 13, the failure/restoration notice function by which the program notifies the management device 13 of a faulty or restored area via the network and the device information update function by which the program manages device information 33 of its own device and updates the device information 33 if any change is made.

In the case of a server, for example, the device information 33 includes information such as server operational status, application programs executed in the server and transmission lines used although detailed examples of the device information 33 are discussed later.

A manager program 34 of the management device 13 includes the device information acquisition function and the failure/restoration notice receipt function. The device information acquisition function allows the management device 13 to instruct the agent-program-installed devices to transmit the device information 33 and allows information from individual devices to be stored as device information 35. The failure/restoration notice receipt function allows the management device 13 to start a transmission line management program 36 and perform appropriate processing upon receipt of a failure or restoration notice.

Transmission line connection information includes information such as application programs executed in the server, transmission lines used for execution of such application programs and devices comprising such transmission lines although detailed examples of transmission line connection information are discussed later.

The transmission line management program 36 is started by the management device 13 if a failure or restoration is detected and includes the transmission line connection information update function by which transmission line connection information 37 is updated from the device information 35 and the transmission line start/stop command function by which the program allows the server using the related transmission line to stop or start using that transmission line in the event of detection of a failure or restoration.

In order to perform tasks on a server, it is necessary to enter a valid user name and his or her password for logging into the server. The management device 13 uses login information 38 which is required for logging into the server to perform automatic processing when executing the transmission line management program 36.

Note that telnet, HTTP (Hyper Text Transfer Protocol) and SNMP are among protocols used for communications between manager and agent programs via a network shown in FIG. 4.

Note also that it is possible to combine the manager program 34 and the transmission line management program 36 into a single program.

Further, it is also possible to provide a configuration with no dedicated management device 13 by installing the management device 34 and the transmission line management program 36 onto the server.

Although the clients 20 are not among those devices to be managed in FIG. 4, it is also possible to include the clients 20 as devices to be managed and install the agent program 32.

The functions shown in FIG. 4 allow the devices comprising transmission lines and their statuses to be managed as transmission line connection information based on the device information 35 collected by the management device 13 and allow the management device 13 to perform appropriate processing for the server which uses the affected transmission line if it detects a failure or restoration.

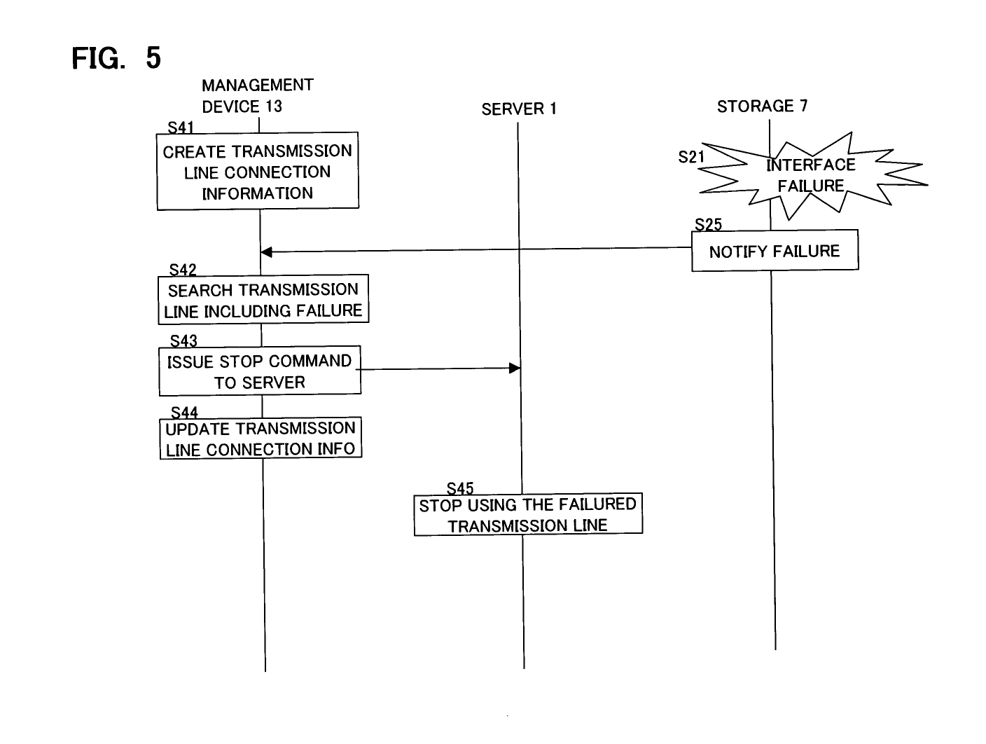

Next, the transmission line control processing in the event of a failure or restoration in the present invention is described by using FIGS. 5 to 8.

FIG. 5 shows the first transmission line control processing according to the present invention. FIG. 5 is described by referring to FIG. 1 which illustrates an example of configuration in which a server and a storage are directly connected. The first transmission line control processing is an example in which the management device 13 receives, in the event of a failure of the connection module 8 of the storage 7, the faulty area through the failure/restoration notice function of the agent program 32 and causes the server 1 to stop using the transmission line 11.

First, transmission line connection information is created by the management device 13 based on the device information 35 (S41). Transmission line connection information regarding the server 1 and the storage 7 can be created based on the device information 33 regarding the server 1 and the storage 7 collected by the management device 13.

Next, let us suppose that a failure occurs in the connection module 8 which is the interface of the storage 7 (S21). Since the storage 7 has the failure notice function of the agent program 32, the management device 13 is notified of the faulty area (S25). The management device 13 searches the transmission line connection information 37 for the transmission line containing the faulty area of which it was notified (S42). This is accomplished simply by comparing devices comprising the transmission line with the faulty area of which the management device 13 was notified and determining if there is any match. This time, the transmission line 11 is applicable.

If the transmission line containing the faulty area is found in Step 42, the management device 13 commands the server which executes the application program using that transmission line to stop using the transmission line containing the faulty area (S43). The management device 13 learns from the transmission line connection information 37 that the application program using the transmission line 11 is executed by the server 1. The login information 38 of the server 1 is used to automatically log into this server and ensure that the transmission line 11 is not used when the server 1 executes the application program 4.

Then the management device 13 updates the transmission line connection information 37 (S44). This update is intended to make a change, in response to the failure notice, to the transmission line 11 status advising of unavailability of this transmission line. The server 1 stops using the transmission line 11 upon receipt of the stop command in Step S43 (S45).

Note that the faulty area of the first transmission line control processing is not limited to the connection module 8, provided that the management device can be notified of it. More specifically, it may be a server's host adapter or disk device. It may also be a fiber channel switch if the SAN configuration is used. Note also that the faulty area may be a connection cable if the server 1 or the storage 7 can detect disconnection of a connection cable in the transmission line 11 and notify the management device. Moreover, the storage 7 may be a tape device.

Detection of the faulty area by the management device and execution of the application program by the server through the first transmission line control processing and the agent program 32's failure/restoration notice function make it possible to automatically cause that server to stop using the transmission line containing the faulty area before an access using the transmission line containing the faulty area takes place. This prevents degradation in server processing performance caused by the server waiting for response from the transmission line containing the faulty area. Moreover, automatic stoppage of transmission line allows the system administrator to devote his or her energies to failure analysis and parts replacement at the faulty area from the beginning, thus ensuring speedy actions to correct the condition in the faulty area.

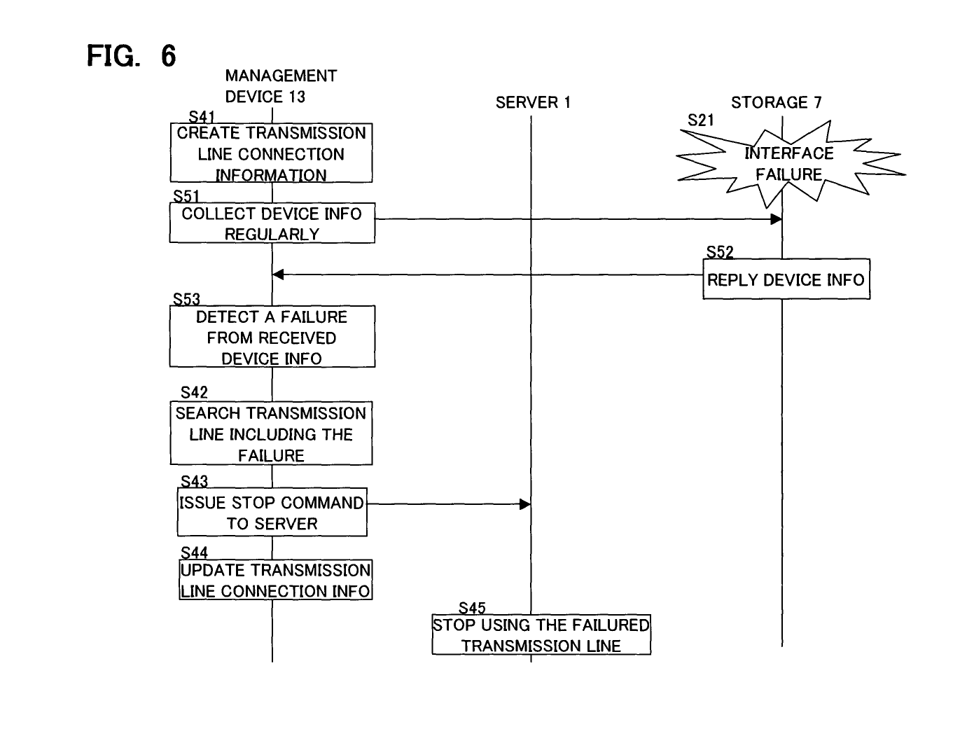

FIG. 6 is the second transmission line control processing according to the present invention. This example illustrates a case in which, following occurrence of a failure in a connection module of a storage which cannot notify the management device 13, the management device 13 detects the faulty area from the device information 35 collected on a regular basis and causes the server, which uses the transmission line containing the faulty area, to stop using that transmission line. FIG. 6 is described by referring to the network calculator system shown in FIG. 1 as with the description of FIG. 5.

First, the transmission line connection information 37 is created by the management device 13 based on the device information 35 (S41). Next, let us suppose that the connection module 8 at the storage 7 becomes faulty (S21). In response to Step S21, the fact that the connection module 8 is defective is recorded in the device information 33 of the storage by the device information update function of the agent program 32. The management device 13 acquires the device information on a regular basis from the devices which it manages (S51). As part of Step S51, the storage 7 returns the device information 33 in reply to a request from the management device 13 (S52).

The management device 13 uses the received device information 33 to detect the area, in which the device status is abnormal, as the faulty area (S53). Since it becomes evident from the received device information 33 that the status of the connection module 8 is abnormal, the management device 13 detects a failure of the connection module 8.

Subsequent processing is omitted since it is the same as the first failure response processing. Note that the second transmission line control processing is applicable to any device provided that the agent program is installed, and the faulty area is not limited to the connection module 8 as with the first transmission line control processing.

The second transmission line control is applicable, for example, if the management device 13 cannot be notified since the cable connecting the storage 7 and the network 15 is disconnected or if the failure/restoration notice function of the agent program 32 does not work properly. Even in such cases, it is possible to detect an occurrence of failure by the management device 13 and then automatically cause the server, which uses the transmission line containing the faulty area, to stop using the transmission line containing the faulty area.

This prevents degradation in server processing performance as a result of the server accessing data by using the transmission line containing the faulty area during execution of the application program in the server. Note also that automatic stoppage of the transmission line allows the system administrator to devote his or her energies to failure analysis and parts replacement at the faulty area from the beginning, thus ensuring speedy actions to correct the condition in the faulty area.

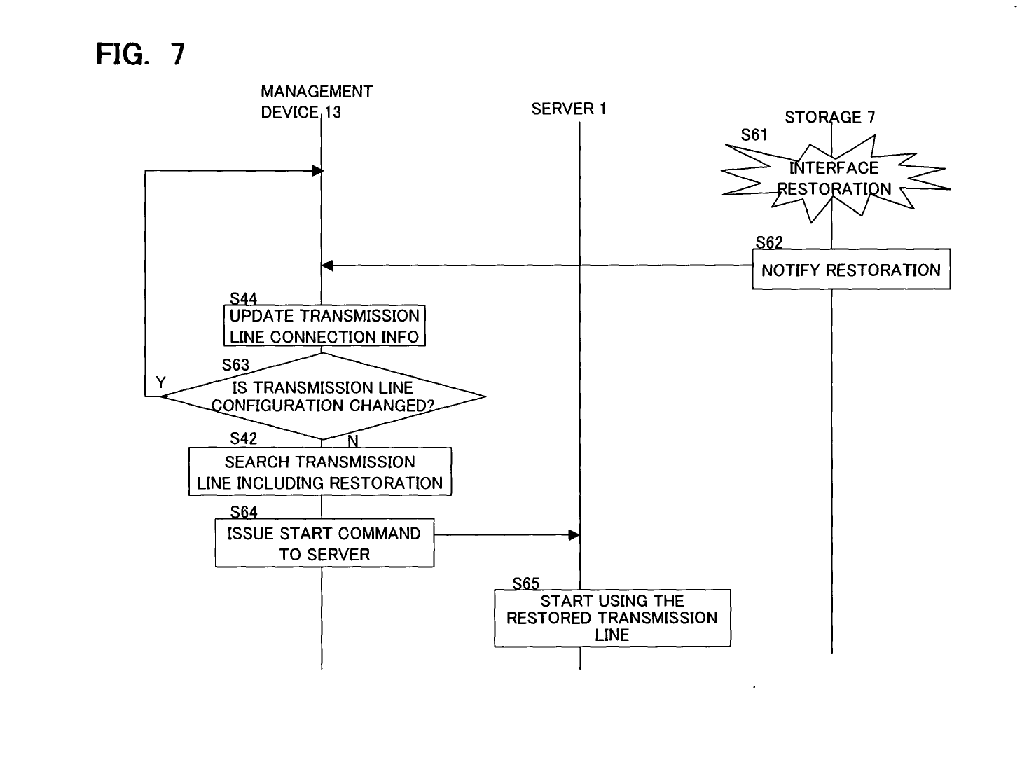

FIG. 7 is the third transmission line control processing according to the present invention. Unlike the first and second control processing, this control is used for restoration at the completion of parts replacement at the faulty area. With the third transmission line control processing, the transmission line is restored to proper working condition at the completion of parts replacement of the faulty connection module. In this example, the management device 13 is notified of restoration by the agent program 32, and the server, which was using the transmission line containing the restored area prior to the failure, is automatically caused to start using the restored transmission line. FIG. 7 is described by referring to the network calculator system shown in FIG. 1 as with the description of FIG. 5.

First, let us suppose that parts replacement of the faulty connection module 8 is complete at the storage 7 (S61). The agent program 32 notifies the management device 13 that the connection module 8 has been restored (S62). The management device 13 receives a restoration notice and updates the transmission line connection information 37 (S44). Then it compares this information with the previous transmission line connection information 37 to determine whether any change has been. made to the transmission line configuration (S63). Step S63 is performed to prevent attempts of the application program to access incorrect data, which the program would make if use of the transmission line was started as is, since any change to the connection status means that the network calculator system configuration has been changed.

Next, the management device 13 searches the transmission line connection information 37 for a transmission line containing the restored area of which the management device 13 was notified (S42). This is accomplished simply by comparing devices comprising the transmission line with the restored area of which the management device 13 was notified and determining if there is any match. This time, the transmission line 11 containing the connection module 8 is applicable.

If a transmission line containing the restored area is found in Step 42, the server using that transmission line is caused to start using the transmission line (S64). Step S64 can be performed in the same manner as with Step S43 of the first transmission line control processing. The only difference from the Step S43 is that the server is commanded to start using the transmission line. Then the server 1 uses the transmission line 11 in response to the start command issued in Step S63 to execute the application program (S65).

Note that the third transmission line control processing is applicable to any device provided with the failure/restoration notice function of the agent program 32, and the restored area is not limited to the connection module 8. For example, it may be a server's host adapter or disk device. It may also be a fiber channel switch if the SAN configuration is used.

The third transmission line control processing allows the management device 13 to detect restoration, provided that the device comprises the failure/restoration notice function of the agent program 32. If the network calculation system's connection status remains the same as before the failure, it is possible to automatically cause the server, which was using the transmission line containing the restored area, to start using the restored transmission line. This automates the processing performed by the system administrator every time a restoration task occurs, thus taking part of the burden off the system administrator.

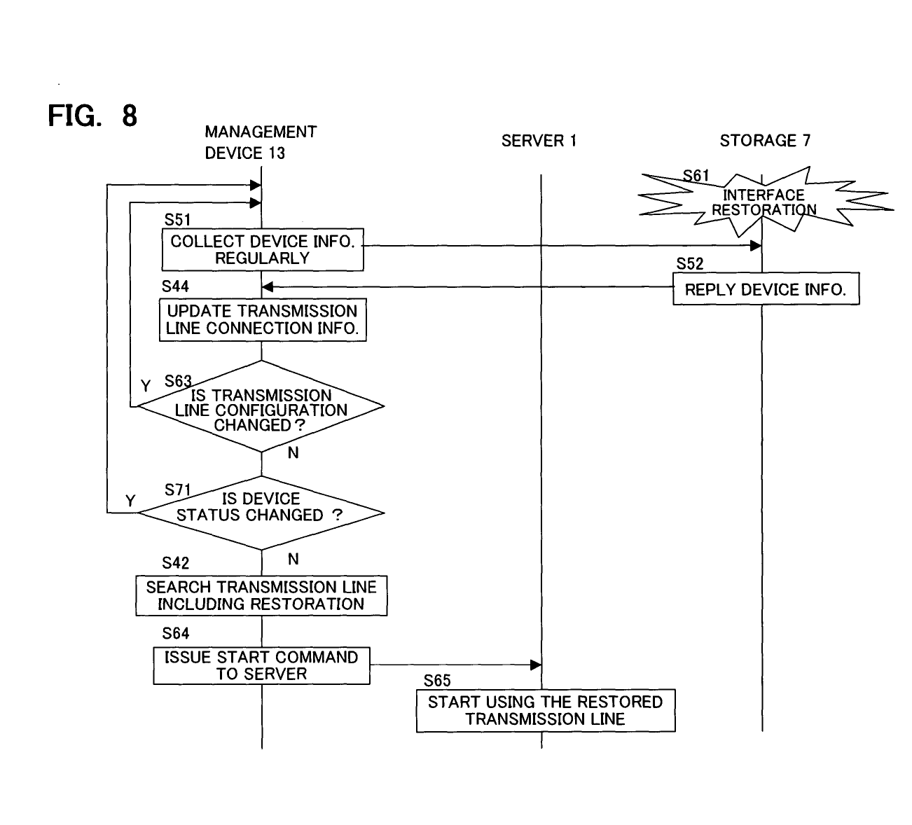

FIG. 8 is the fourth transmission line control processing of the present invention. As with the third transmission line control processing, this control is used for restoration of the faulty area. With the fourth transmission line control processing, when replacement of the faulty connection module is complete at a storage which cannot notify the management device 13 of the restored area, the management device 13 detects the restored area from the device information 35 which it collects on a regular basis. Then the server, which was using the transmission line containing the restored area prior to the failure, is caused to start using that transmission line in this example. FIG. 8 is described by referring to the network calculator system shown in FIG. 1 as with the description of FIG. 5.

First, let us suppose that replacement of the faulty connection module 8 at the storage 7 is complete (S61). The device status update function of the agent program 32 updates the storage device information 33 to change the connection module 8 status from abnormal condition to normal condition. The management device 13 acquires the device information on a regular basis from the devices which it manages (S51). As part of Step S51, the storage 7 returns the device information 33 in reply to a request from the management device 13 (S52).

The management device 13 updates the device information 35 from the acquired device information 33 and updates the transmission line connection information based on the device information 35 (S44). Then it compares this information with the previous transmission line connection information 37 to determine whether any change has been made to the transmission line configuration (S63).

If it finds that no change has been made to the transmission line configuration in Step S63, it compares the current information with the previous device information 35 and determines that the device whose status has changed from abnormal condition to normal condition is the restored area (S71). In Step S71, the connection module 8 is judged as being the restored area as its status has been changed by Step S61. Subsequent processing is omitted since it is the same as the third transmission line control processing.

The fourth transmission line control is applicable, for example, when the management device 13 cannot be notified since the cable connecting the storage 7 and the network 15 is disconnected or when the failure/restoration notice function of the agent program 32 does not work properly. Even in such cases, it is possible to detect an occurrence of restoration by the management device 13 and then automatically cause the server, which uses the transmission line containing the restored area, to stop using the transmission line containing the restored area.

The fourth transmission line control processing automates the processing performed by the system administrator every time a restoration task occurs, thus taking part of the burden off the system administrator.

The embodiments of the invention and transmission line control processing of the present invention in the event of a failure or restoration have been discussed above, and device configurations associated with the embodiments of the invention are described next.

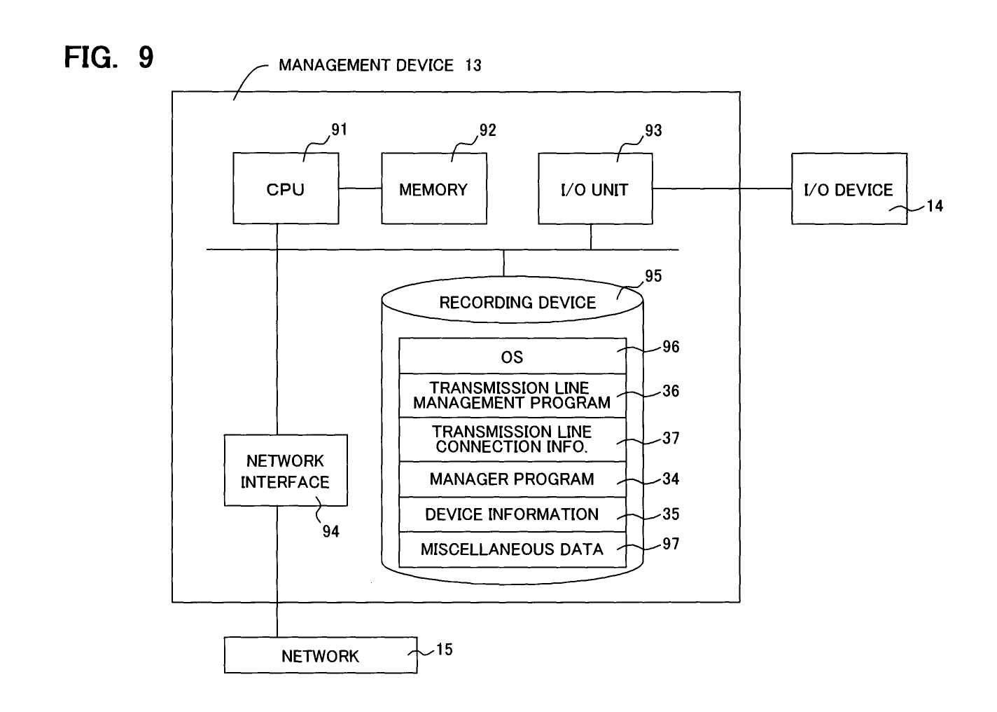

FIGS. 9 to 12 illustrate examples of management device, server, storage and fiber channel switch configurations.

FIG. 9 shows an example of management device configuration. The management device 13 is provided with an CPU 91 which performs computation, a memory 92 for storing data such as arithmetic data, a network interface 94 for connection to the network 15, an input/output unit 93 for connection to the external input/output device 14 and a recording device 95 for recording data and programs.

The recording device 95 stores the device information 35 collected from an operating system 96 and the managed devices, the manager program 34, the transmission line connection information 37 including transmission line configuration information, the transmission line management program 34 and miscellaneous data 97. Specific examples of the transmission line connection information 37 and the device information 35 are discussed later.

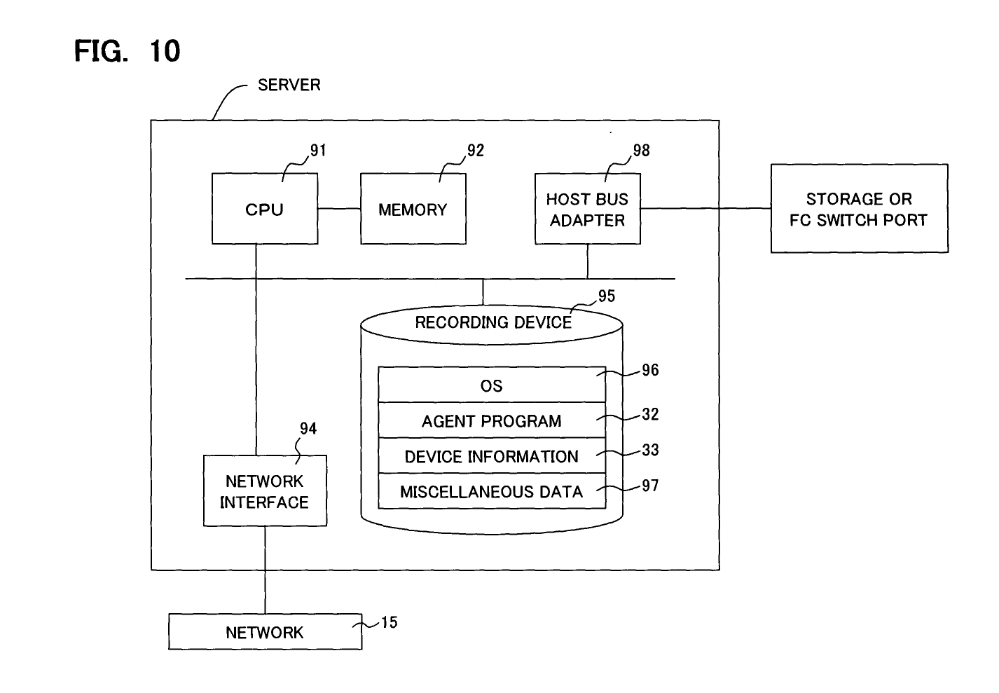

FIG. 10 shows an example of server configuration. The server is provided with the CPU 91 which performs computation, the memory 92 for storing data such as arithmetic data, the network interface 94 for connection to the network 15, a host bus adapter 98 for connection to a storage or fiber channel switch and the recording device 95 for recording data and programs.

The recording device 95 stores the device information 33 on the operating system 96 and the server, the agent program 32 and the miscellaneous data 97.

The clients 20 have the same configuration as the server in FIG. 10. Note, however, that if there is no particular need for connection to peripherals, the host bus adapter 98 is not required. Note also that if one chooses not to include the clients among devices to be managed as the system administration policy, it is not necessary to provide the agent program 32 and the device information 33.

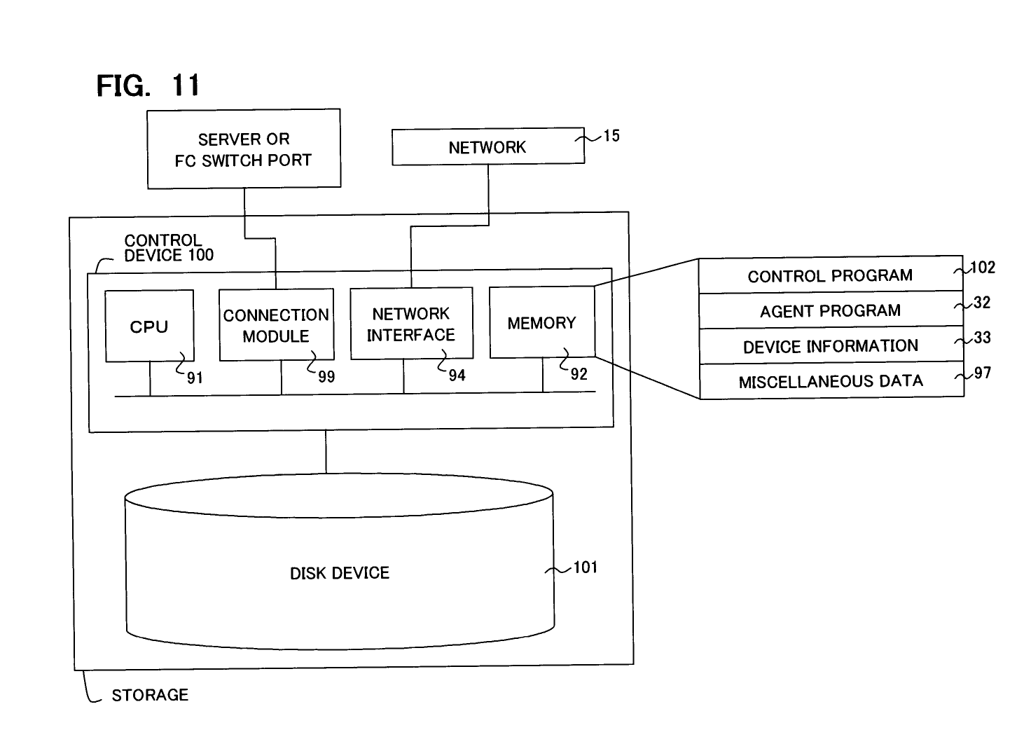

FIG. 11 shows an example of storage configuration. The storage has a management device 100 comprising the CPU 91 which performs computation, the memory 92 for storing data such as arithmetic data, the network interface 94 for connection to the network 15 and a connection module 99 for connection to a server or a fiber channel switch, and a disk device 101 managed by the management device 100.

The memory 92 contains a control program 102 for controlling the entire storage, a device information management program 32, the device information 33 and the miscellaneous data 97. It is possible to choose a configuration in which the functions stored in the memory 92 in FIG. 11 are provided in the form of devices such as IC chips and not in the form of programs. Note that it is also possible to use a tape device in place of the disk device 101 as the storage.

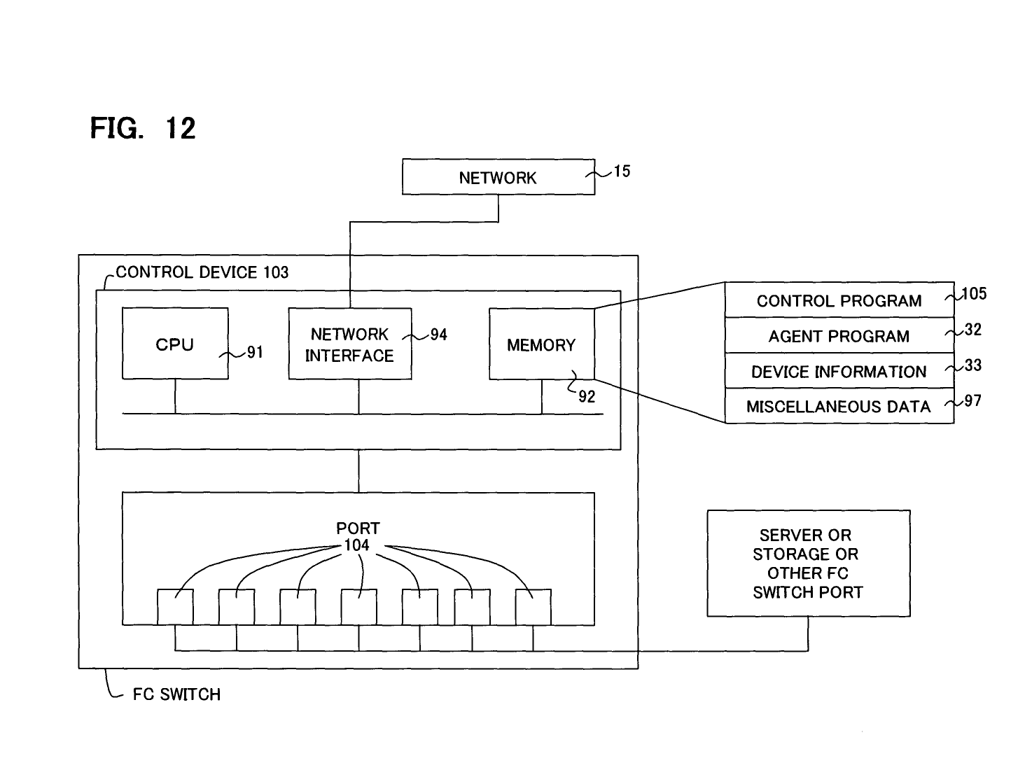

FIG. 12 shows an example of fiber channel switch configuration. The fiber channel switch has a management device 103 comprising the CPU 91 which performs computation, the memory 92 for storing data such as arithmetic data and the network interface 94 for connection to the network 15, and a port 104 managed by the management device 103. The port 104 is connected to ports, servers or storages of other fiber channel switches.

The memory 92 contains a control program 105 for controlling the fiber channel switch, the agent program 32, the device information 33 and the miscellaneous data 97. It is possible to choose a configuration in which the functions stored in the memory 92 in FIG. 11 are provided in the form of devices such as IC chips.

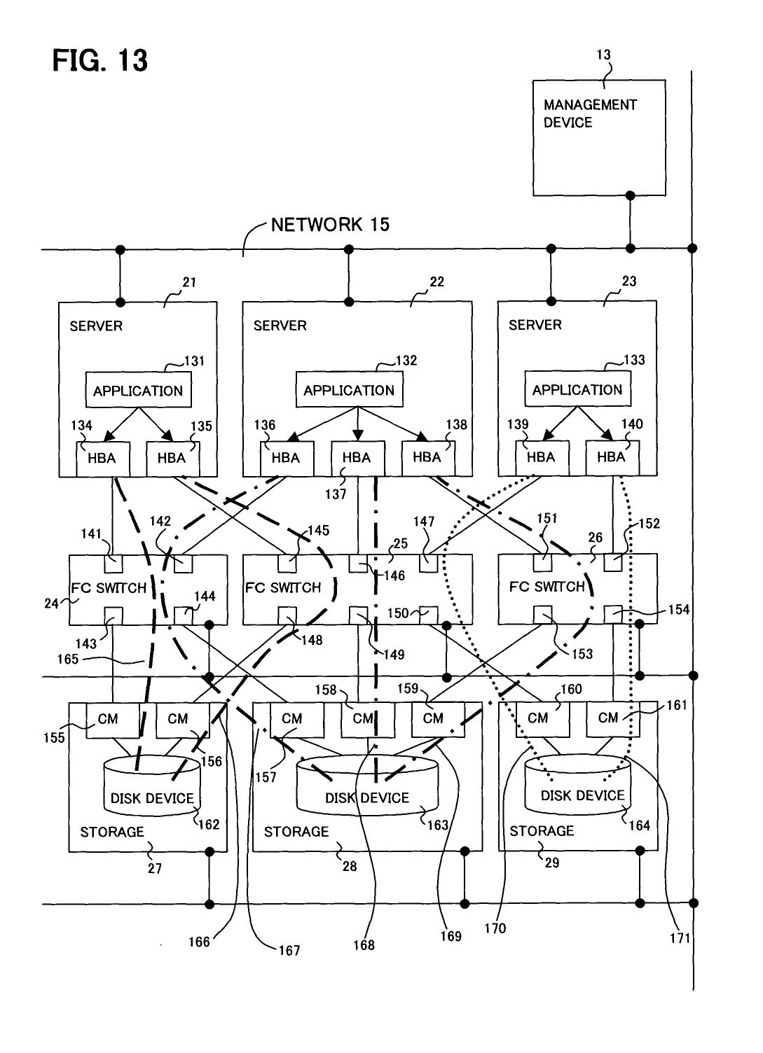

Transmission line control processing in the event of a failure or restoration and configurations of individual devices associated with the embodiments of the present invention have been discussed above. Device information, transmission line connection information and transmission line connection information update processing are described below in a concrete manner by applying the first transmission line control processing to the SAN configuration shown in FIG. 13.

FIG. 13 illustrates another example of network calculator system configuration to which the first transmission line control processing is applied. FIG. 13 shows the details of the domain 31 of the network calculator system shown in FIG. 3, and each of the servers 21, 22 and 23, the fiber channel switches 24, 25 and 26 and the storages 27, 28 and 29 is connected to the network 15.

In each server, data obtained from the storage is processed by the application program which is executed on the server, and processing results are provided to the unillustrated clients. Since the agent program 32 is installed onto the servers 21, 22 and 23, the storages 24, 25 and 26 and the fiber channel switches 27, 28 and 29, these devices are provided with the device information transmission function and the failure/restoration notice function. The manager program is installed onto the management device 13.

The server 21 uses two transmission lines, namely, transmission lines 165 and 166, when executing an application program 131. The transmission line 165 runs up to a disk device 162 via a host bus adapter (HBA) 134 of the server 21, ports 141 and 143 of the fiber channel switch (FC switch) 24 and a connection module (CM) 155 of the storage 27. The transmission line 166 runs up to the disk device 162 via an HBA 135 of the server 21, ports 145 and 148 of the FC switch 25 and a CM 156 of the storage 27.

In the server 22, an application program 132 uses three transmission lines or transmission lines 167, 168 and 169. The transmission line 167 runs up to a disk device 163 via an HBA 136 of the server 22, ports 142 and 144 of the FC switch 24 and a CM 157 of the storage 28. The transmission line 168 runs up to the disk device 163 via an HBA 137 of the server 22, ports 146 and 149 of the FC switch 25 and a CM 158 of the storage 28. The transmission line 169 runs up to the disk device 163 via an HBA 138 of the server 22, ports 151 and 153 of the FC switch 26 and a CM 159 of the storage 28.

In the server 23, an application program 133 uses two transmission lines or transmission lines 170 and 171. The transmission line 170 runs up to a disk device 164 via a host bus adapter 139 of the server 23, ports 147 and 150 of the FC switch 25 and a connection module CM 160 of the storage 29. The transmission line 171 runs up to the disk device 164 via an HBA 140 of the server 23, ports 152 and 154 of the FC switch 26 and a CM 161 of the storage 29.

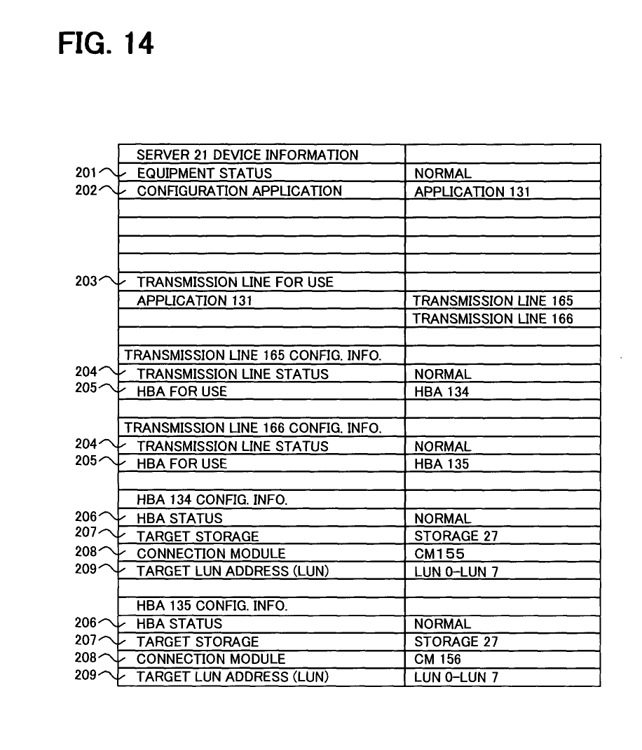

FIGS. 14 to 16 show examples of the device information 33 stored in the servers.

FIG. 14 illustrates an example of device information stored in the server 21. This information contains an equipment operational status 201 indicating the server operational status, a configuration application 202 indicating the application program executed in the server, a transmission line for use 203 which is the transmission line used by the server during execution of the configuration application, a transmission line operational status 204 showing whether the transmission line for use is available, an HBA for use 205 indicating the host bus adapter used by the transmission line for use 203, an HBA status 206 indicating the status of the HBA for use 205, a target storage 207 to which the HBA for use 205 will be eventually connected, a connection module 208 used for connection to the target storage 207 and logical addresses (LUN) 209 which are numbers representing the access domain in the target storage 207.

Logical addresses (LUNs) are numbers assigned to virtual disks. For example, even if a storage device physically has only one hard disk, the hard disk can be virtually divided by a program installed onto the server or the storage's controller, thus making the disk device look to the server as if the device had a number of hard disks. Logical addresses are numbers used to access these divided and virtual hard disks. Use of logical addresses allows flexible utilization of disk devices.

FIG. 14 makes it evident that the equipment operational status is normal since the server is not faulty. The configuration application in the server 21 is the application 131 as shown in FIG. 13. The application 131 uses the transmission lines 165 and 166, and the transmission line 165 uses the HBA 134 while the transmission line 166 uses the HBA 135.

The server 21 acquires information on the storages to which the HBAs are connected and defines that information in the target storage 207, the connection module 208 and the target logical addresses 209. It is possible to learn from FIG. 14 that the HBA 134 is connected to the connection module CM 155 of the storage 27 and that LUNs 0 through 7 are accessible. Similarly, it becomes evident that the HBA 135 is connected to the connection module CM 156 of the storage 27 and that the LUN0 through 7 are accessible.

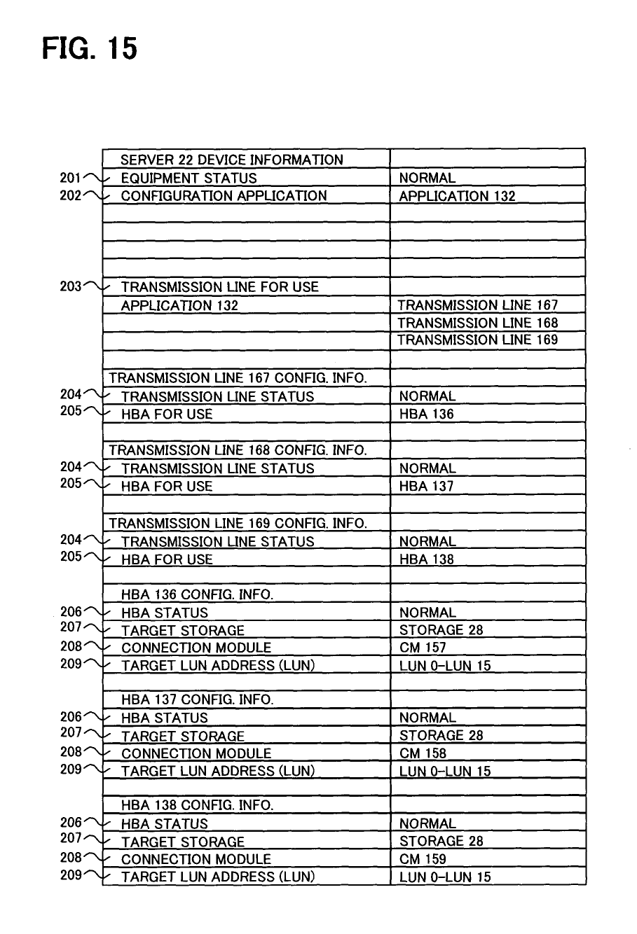

FIG. 15 shows an example of device information stored in the server 22. Detailed description is omitted since the device information items are the same as those of the server 21. It becomes evident, for example, that three transmission lines or the transmission lines 167, 168 and 169 are used during execution of the application 132 in the server 21.

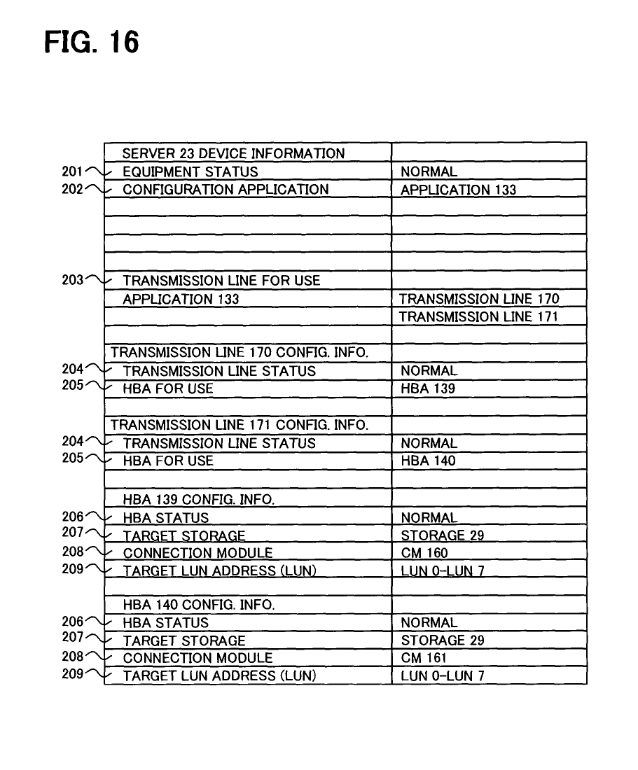

FIG. 16 shows an example of device information stored in the server 23. Detailed description is omitted since the device information items are the same as those of the server 21. It becomes evident, for example, that two transmission lines or the transmission lines 170 and 171 are used during execution of the application 133 in the server 22.

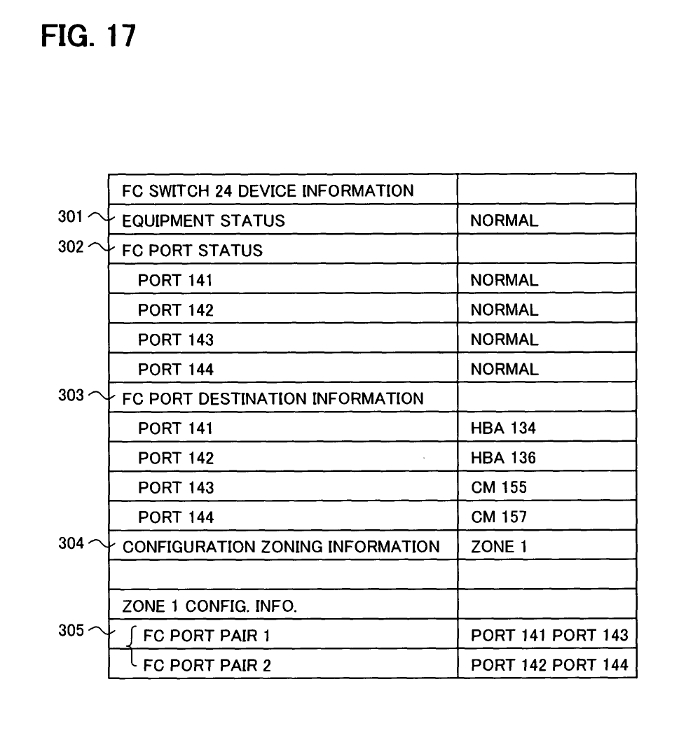

FIGS. 17 to 19 show examples of device information stored in fiber channel switches.

FIG. 17 shows an example of device information stored in the fiber channel switch 24. As the fiber channel switch 24's device information, the device information contains an equipment operational status 301 indicating the fiber channel switch operational status, port operational statuses 302 indicating the port operational statuses, port destination information 303 indicating the destinations to which the ports are connected, configuration zoning information 304 indicating the port groupings and port pairs 305 indicating in-zone pairs of ports.

Zoning refers to grouping of a plurality of ports when a plurality of ports is available for one fiber channel switch. The advantage of zoning is that it is possible to restrict access to ports which belong to different zones. This function prevents the server from erroneously accessing storages belonging to other zones, thus allowing servers and storages to be used to meet the independent application of each zone by only one fiber channel switch without the need to have ready a plurality of fiber channel switches.

Moreover, a connection line is used when a fiber channel switch is connected to a server, storage or other fiber channel switch, and since it is possible to learn about interface or port information of the device to which the fiber channel switch is connected, port destination information is obtained in that manner.

In FIG. 17, the equipment operational status is normal since the fiber channel switch 21 is not faulty. The port operational status 302 of each port is normal. It becomes evident that the ports 141, 142, 143 and 144 are connected respectively to the HBA 134 of the server 21, the HBA 136 of the server 22, the CM 155 of the storage 27 and the CM 157 of the storage 28. A zone 1 is comprised of the configuration zoning information 304, and there are two pairs of ports, one pair of the ports 141 and 143 and the other pair of the ports 142 and 144, in the zone 1.

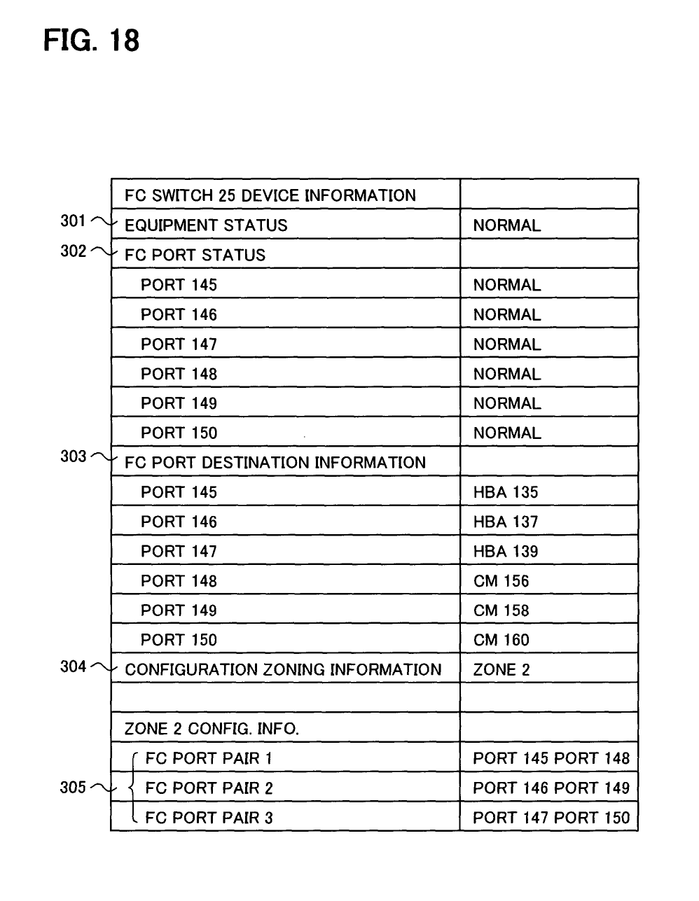

FIG. 18 shows an example of device information stored in the fiber channel switch 25. Detailed description is omitted since the device information items are the same as those of the server 24. It becomes evident that the fiber channel switch 25 has three pairs of ports in a zone 2 and that they serve as intermediate for connection between the host bus adapters of the server 22 and the connection modules of the storage 28.

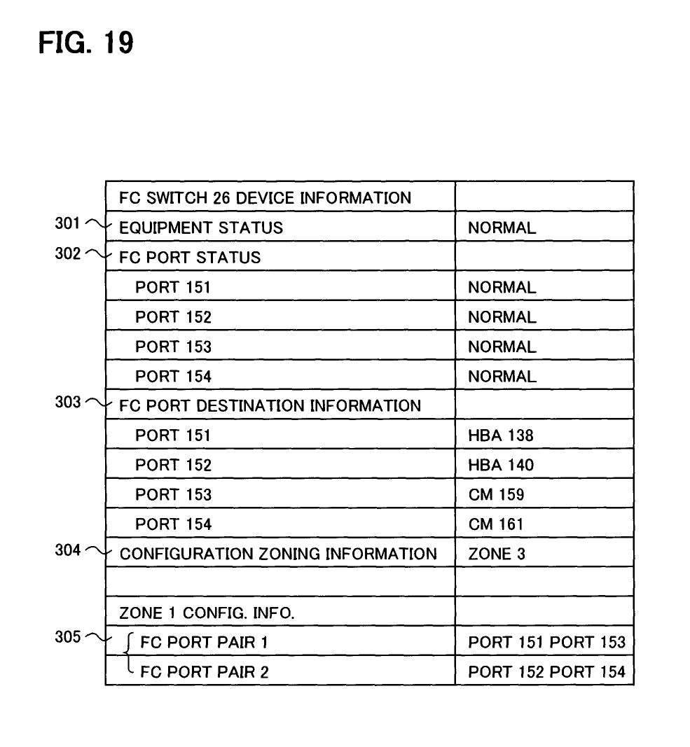

FIG. 19 shows an example of device information stored in the fiber channel switch 26. Detailed description is omitted since the device information items are the same as those of the server 24. It becomes evident that the fiber channel switch 26 has two pairs of ports in a zone 3 and that they serve as intermediate for connection between the host bus adapters of the server 23 and the connection modules of the storage 29.

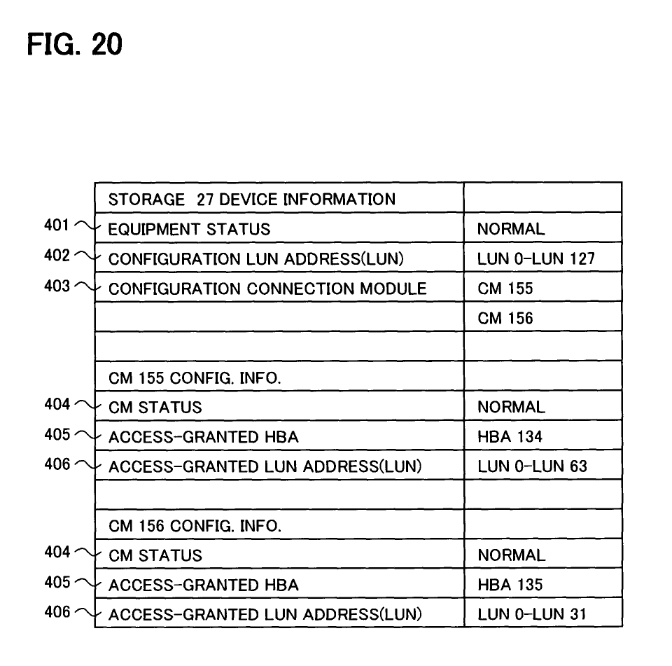

FIGS. 20 to 22 show examples of device information stored in storages.

FIG. 20 shows an example of device information stored in the storage 27. This information contains an equipment operational status 401 indicating the storage operational status, configuration logical addresses 402 indicating storage-definable logical address, a configuration connection module 403 indicating the interface available with the storage, an operational status 404 indicating the operational status of the configuration connection module 403, an access-granting HBA 405 indicating the HBA which grants connection to the configuration connection module 403 and access-granting logical addresses 406 indicating the extent to which the configuration connection module can access the configuration logical addresses 402.

The configuration logical addresses 402 are the maximum number of logical addresses which can be defined by the management device 100 (FIG. 11) while the access-granting logical addresses 406 represent the number of logical addresses defined for each connection module such that the configuration logical addresses 402 are not exceeded. Note that it is not possible to access data in the storage if a host bus adapter other than that specified by the access-granting HBA 405 is connected to that connection module.

In FIG. 20, the equipment operational status 401 is normal since the storage 27 is not faulty. The configuration logical addresses 402 are LUN0 to LUN127. It becomes evident that the storage 27 has the connection modules CM 155 and CM 156. The operational status 404 of the CM 155 is normal. The access-granting HBA 405 of the CM 155 is the HBA 134, and data in the storage cannot be accessed if connection is made to an HBA other than this HBA. The access-granting logical addresses 406 are LUN0 to LUN63.

The common portion (logical product) of the target logical addresses 209 defined in the server 21 to which the CM 155 is connected and the access-granting logical addresses 406 defined in the storage 27 is the logical addresses which can be practically accessed.

Similarly, the operational status 404 of the CM 156 is normal. It becomes evident that the access-granting HBA 405 of the CM 156 is the HBA 135 and that the access-granting logical addresses 406 are LUN0 to LUN31.

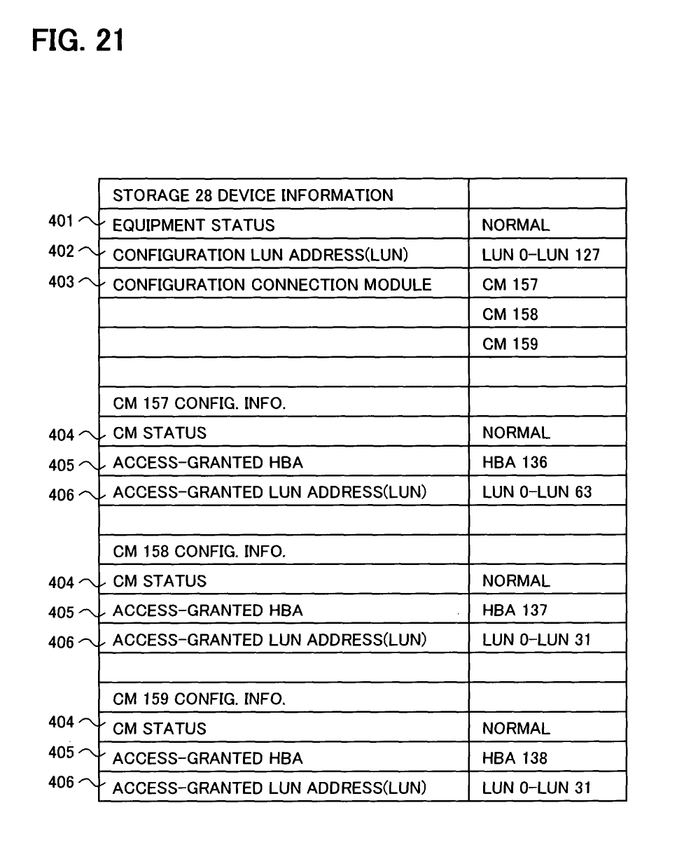

FIG. 21 shows an example of device information stored in the storage 28. Detailed description is omitted since the device information items are the same as those of the server 27. It becomes evident that the storage 27 has three connection modules and that each of these connection modules is connected to the server 22.

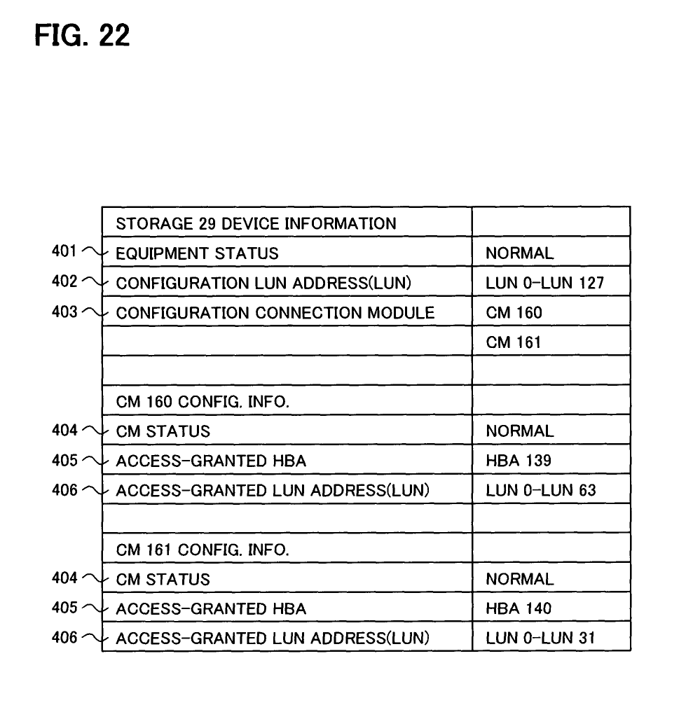

FIG. 22 shows an example of device information stored in the storage 29. Detailed description is omitted since the device information items are the same as those of the server 27. It becomes evident that the storage 27 has two connection modules and that each of these connection modules is connected to the server 23.

The management device 13 collects the device information 33 shown in FIGS. 14 through 22 by the manager program's function, brings together all pieces of information and stores them as the device information 35 to create the transmission line connection information 37. For this reason, update processing of transmission line connection information is described next in which the transmission line connection information 37 is created from the device information 35.

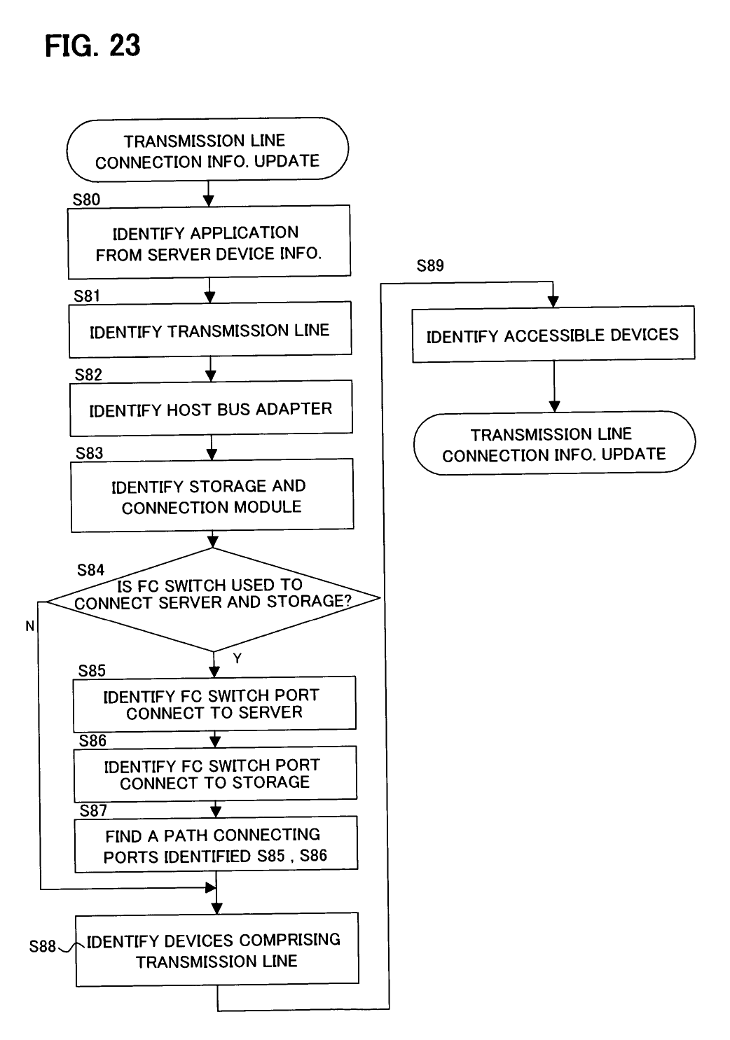

FIG. 23 is a flowchart representing update processing of transmission line connection information designed to create the transmission line connection information 37 from the device information 35.

First, the application program which is executed in the server is identified from server device information (S80). This is accomplished simply by selecting the configuration application 202 from the server device information. Next, the transmission line, which is be used by the server when the application program obtained in Step S80 is executed, is identified (S81). This is accomplished simply by selecting the transmission line for use 203 from the server device information 33.

Next, the host bus adapter, which is used by the transmission line obtained in Step S81, is identified (S82). This is accomplished simply by selecting the HBA for use 205 from the server device information. The storage to which the HBA obtained in Step S82 is connected and the connection module, which is be used, are identified (S83). This is accomplished simply by selecting the target storage 207 and the connection module 208 from the server device information.

Next, judgment is made as to whether a fiber channel switch is used to connect the server and the storage (S84). This is accomplished simply by searching the fiber channel switch's device information to determine whether there is any port which is connected to the same device as the host bus adapter obtained in Step S82 or the connection module obtained in Step S83.

When a matching port is found in Step S84, the port of the FC switch connected to the host bus adapter is identified (S85). Step S85 reveals the server and fiber channel switch connection status. Next, the port of the FC switch connected to the connection module is identified (S86). Step S85 reveals the storage and fiber channel switch connection status.

Then a search is made for the path connecting the ports obtained in Steps S85 and S86 (S87). If the two ports are on the same switch, the port pairs 305 of the switch configuration information are searched for a match. If the two ports are on different switches, a search is made for a path connecting the two switches. In either case, if no path is found which connect the two ports, the transmission line cannot be used as such since it is partitioned.

Next, the devices comprising the transmission line are identified from the connection status between the host bus adapter and the storage module (S88). Step S88 is processed even if the server and the storage are found to be connected directly without any FC switch in Step S84.

If there are limitations to devices which can be accessed by the storage connection module, the accessible devices are identified (S89). Step S89 is accomplished simply by extracting the common portion (logical product) of the target logical addresses 209 of the server device information 33 and the access-granting logical addresses 406.

Transmission line connection information is complete when the above processing is performed for all transmission lines used by the application which is executed in the server.

Next, transmission line connection information is described in a concrete manner.

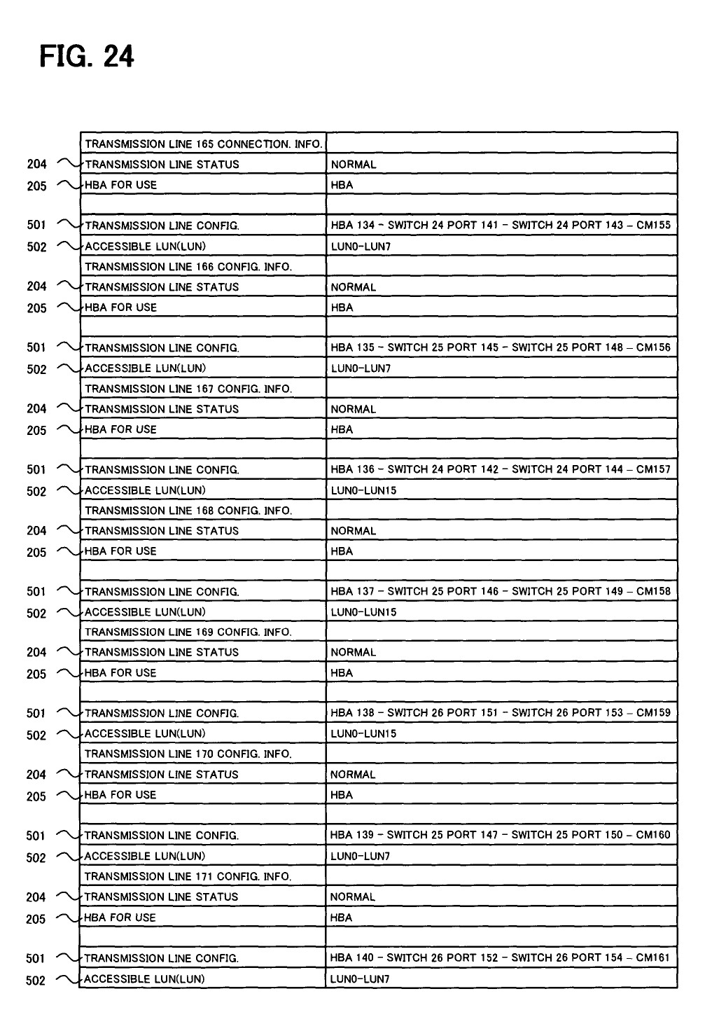

FIG. 24 is an example of transmission line connection information created by the transmission line connection information update processing shown in FIG. 23 using FIGS. 14 through 22.

First, it becomes evident from the device information 33 of the server 21 shown in FIG. 14 that the application 131 is executed in the server 21 and that the server 21 uses the transmission lines 165 and 166 for that execution (Steps S80 and S81 in FIG. 23). Here, attention is focused on the transmission line 165. It becomes evident from the HBA for use 205 in FIG. 14 that the host bus adapter used by the transmission line 165 is the HBA 134 (Step S82). Moreover, it becomes evident from the target storage 207 and the connection module 208 in FIG. 14 that the HBA 134 is connected to the connection module 155 of the storage 27 (Step S83).

Next, judgment is made as to whether a fiber channel switch is used to connect the server and the storage (Step S84). As a result of search of fiber channel switch device information, it becomes evident from the fiber channel switch information in FIG. 17 that the ports 141 and 143 of the fiber channel switch 24 are connected respectively to the host bus adapter 134 and the connection module 155 (Steps S85 and S86).

Moreover, it becomes evident from the port pair information 305 in the fiber channel switch device information in FIG. 17 that the ports 141 and 143 are paired, as a result of which the path linking the ports is found (Step S87).

From the above, it becomes evident that the transmission line 165 runs from the host bus adapter 134 to the connection module 155 of the storage 27 via the ports 141 and 143 of the fiber channel switch 24, as a result of which the connection status which has been found is defined in a transmission line configuration 501 in FIG. 24 (Step S88).

Next, the common portion (logical product) of the target logical addresses 209 defined for the host bus adapter 134 in FIG. 14 and the access-granting logical addresses 406 defined for the connection module 155 in FIG. 20 is taken, and LUN0 to 7 are defined in accessible logical addresses 502 (Step S89). The transmission line connection information in FIG. 24 also contains the transmission line status 204 and the HBA for use 205.

As for transmission lines other than the transmission line 165, the transmission line connection information update processing in FIG. 23 is similarly performed to complete FIG. 24.

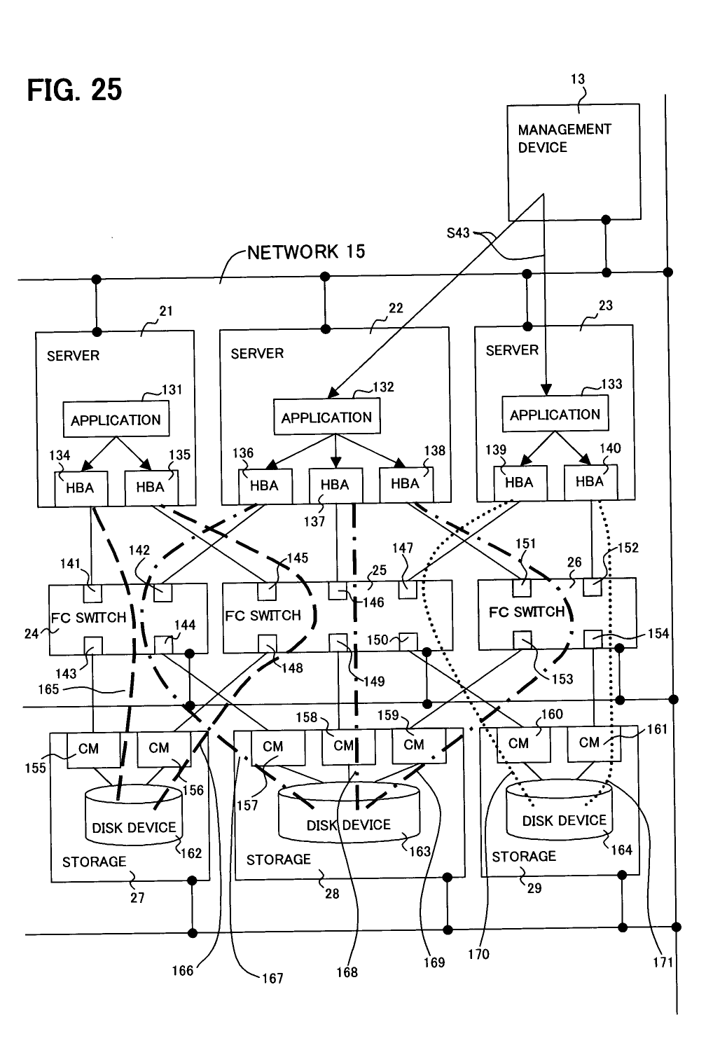

Then cases in which a failure occurs in the SAN configuration shown in FIG. 13 are described in a concrete manner by applying the first transmission line control processing to FIGS. 25 to 28.

FIG. 25 shows an example in which the entire fiber channel switch 26 becomes unavailable and in which the servers 22 and 23, which use the transmission lines 169 and 171, are caused to stop using these transmission lines since they are unavailable for use. In describing FIG. 25, FIG. 5 is referenced by replacing the server 1 in FIG. 5 with the servers 22 and 23 and the storage 7 in FIG. 5 with the fiber channel switch 26. Note also that reference is also made to FIGS. 15, 16 and 24.

First, the management device 13 is notified of a failure by the agent program's failure/restoration notice function of the fiber channel switch 26 (S25 in FIG. 5). The management device 13 searches for the transmission line containing the faulty area (S42). It becomes evident from the transmission line configuration 502 in the transmission line connection information in FIG. 24 that the transmission lines containing the fiber channel switch 26 are the transmission lines 169 and 171.

Next, a stop command is issued to the servers which use the transmission lines (S43). It becomes evident from the transmission line for use 203 in FIG. 15 that the application, which uses the transmission line 169, is the application 132, and it becomes evident from the transmission line for use 203 in FIG. 16 that the application, which uses the transmission line 171, is the application 133. The management device 13 reads the servers, in which the applications 132 and 133 are executed, from the device information, uses the login information 38 to log into the server 22 and cause this server to stop using the transmission line 169. Similarly, it logs into the server 23 and causes this server to stop using the transmission line 171.

The application example in FIG. 25 allows the management device 13 to detect a failure and then automatically cause the servers, which use the transmission lines containing the faulty area, to stop using these transmission lines even if one failure can affect a plurality of transmission lines in the SAN configuration. This prevents degradation in servers' processing performance caused by the servers waiting for response from the transmission lines containing the faulty area.

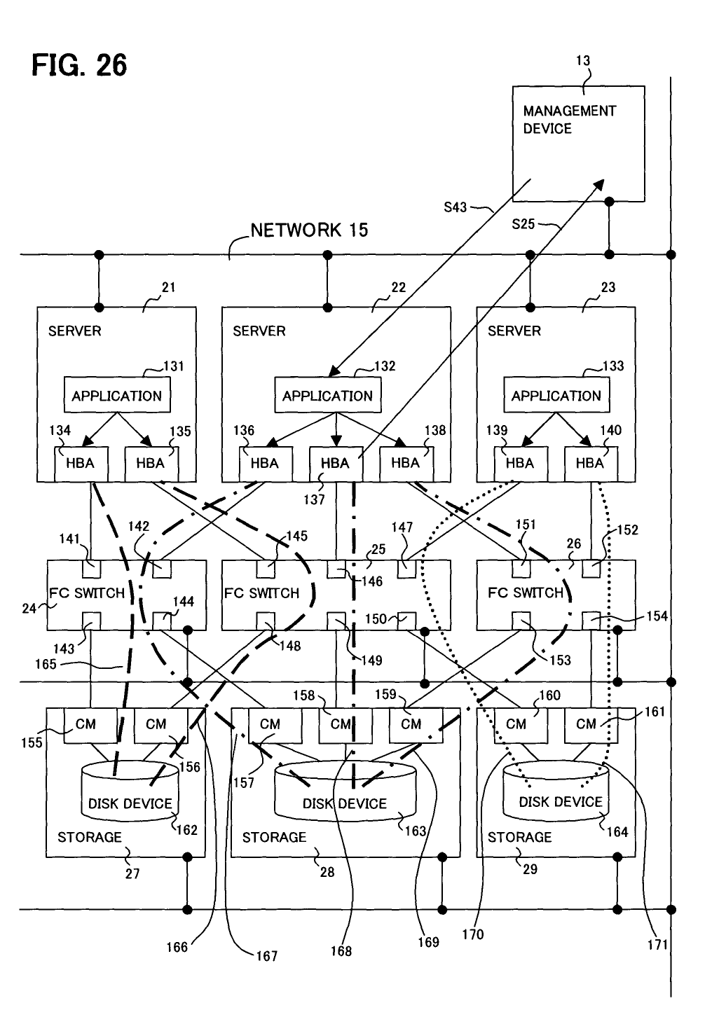

FIG. 26 shows an example in which a failure occurs in the HBA 137 of the server 22 and in which the server 22, which uses the transmission line 169, is caused to stop using this transmission line since it becomes unavailable for use. In describing FIG. 26, FIG. 5 is referenced by replacing the server 1 and the storage 7 in FIG. 5 with the server 22. Note also that reference is also made to FIGS. 15 and 24.

First, the management device 13 is notified by the agent program 32's failure/restoration notice function of the server 22 that a failure has occurred in the HBA 137 (S25 in FIG. 5). The management device 13 searches for the transmission line containing the faulty area (S42). It becomes evident from the transmission line configuration 502 in the transmission line connection information in FIG. 24 that the transmission line containing the HBA 137 is the transmission line 168.

Next, a stop command is issued to the server which uses the transmission line 168 (S43). It becomes evident from FIG. 15 that the application which uses the transmission line 168 is the application 132 and that the application 132 is executed in the server 22. Therefore, the management device 13 uses the login information 38 of the server 22 to log into the server 22 and cause this server to stop using the transmission line 168.

The application example in FIG. 26 allows the management device 13 to detect a failure and then automatically cause the server, which uses the transmission line containing the faulty area, to stop using this transmission line even if the host bus adapter of the server becomes faulty in the SAN configuration. This prevents degradation in server processing performance caused by the server waiting for response from the transmission line containing the faulty area.

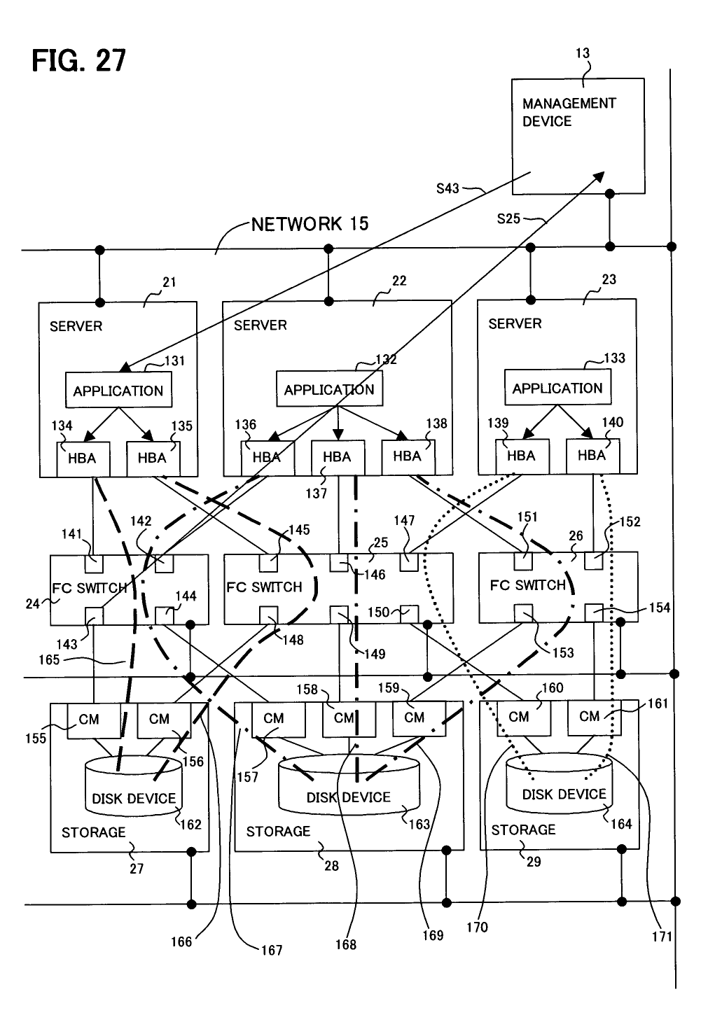

FIG. 27 shows an example in which a failure occurs in the port 143 of the fiber channel switch 24 and in which the server 21, which uses the transmission line 165, is caused to stop using this transmission line since it becomes unavailable for use. In describing FIG. 27, FIG. 5 is referenced by replacing the server 1 and the storage 7 in FIG. 5 respectively with the server 18 and the fiber channel switch 21. Note also that FIGS. 15 and 24 are also described.

First, the management device 13 is notified by the agent program 32's failure/restoration notice function of the fiber channel switch 24 that a failure has occurred in the port 143 (S25 in FIG. 5). The management device 13 searches for the transmission line containing the faulty area (S42). It becomes evident from the transmission line configuration 502 in the transmission line connection information in FIG. 24 that the transmission line containing the port 143 of the fiber channel switch 24 is the transmission line 165.

Next, a stop command is issued to the server which uses the transmission line 165 (S43). It becomes evident from FIG. 14 that the application which uses the transmission line 165 is the application 131 and that the application 131 is executed in the server 21. The management device 13 uses the login information 38 of the server 21 to log into the server 21 and cause this server to stop using the transmission line 165.

The application example in FIG. 27 allows the management device 13 to detect a failure and then automatically cause the server, which uses the transmission line containing the faulty area, to stop using this transmission line even if the fiber channel switch port becomes faulty in the SAN configuration. This prevents degradation in server processing performance caused by the server waiting for response from the transmission line containing the faulty area.

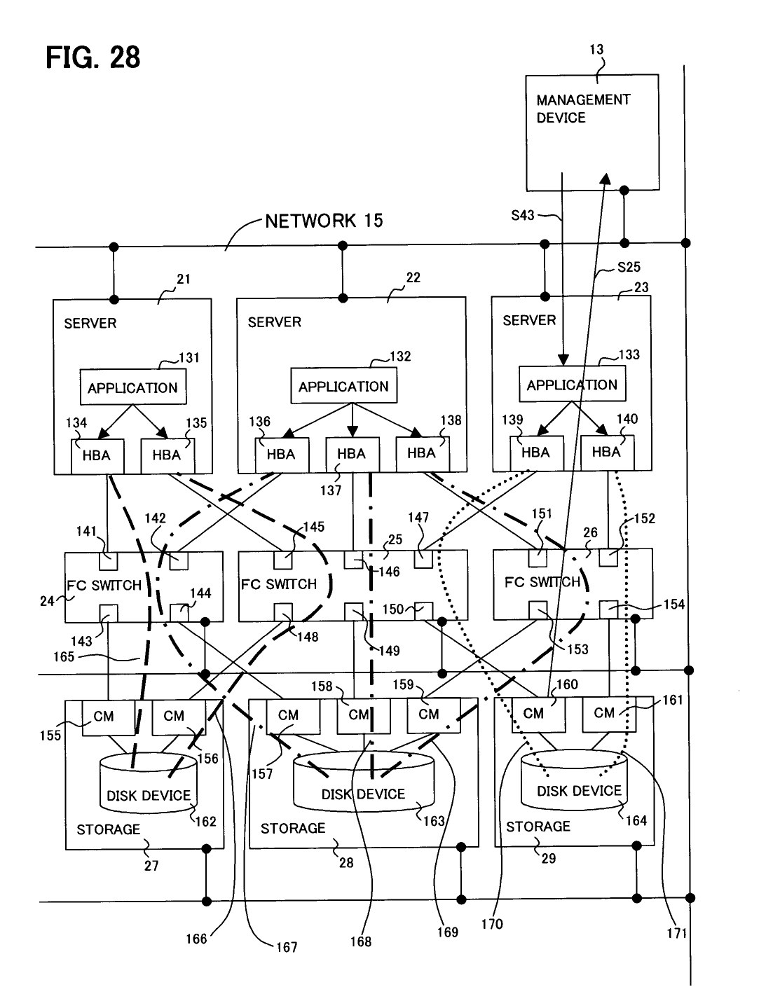

FIG. 28 shows an example in which a failure occurs in a CM 1160 of the storage 29 and in which the 23, which uses the transmission line 170, is caused to stop using this transmission line since it becomes unavailable for use. In describing FIG. 28, FIG. 5 is referenced by replacing the server 1 and the storage 7 in FIG. 5 respectively with the server 20 and the storage 29. Note also that reference is also made to FIGS. 16 and 24.

First, the management device 13 is notified by the agent program 32's failure/restoration notice function of the storage 29 that a failure has occurred in the connection module 160 (S25 in FIG. 5). The management device 13 searches for the transmission line containing the faulty area (S42). It becomes evident from the transmission line configuration 502 in the transmission line connection information in FIG. 24 that the transmission line containing the connection module 160 of the storage 29 is the transmission line 170.

Next, a stop command is issued to the server which uses the transmission line 170 (S43). It becomes evident from FIG. 16 that the application which uses the transmission line 170 is the application 133 and that the application 133 is executed in the server 23. The management device 13 uses the login information 38 of the server 23 to log into the server 23 and cause this server to stop using the transmission line 170.

The application example in FIG. 28 allows the management device 13 to detect a failure and then automatically cause the server, which uses the transmission line containing the faulty area, to stop using this transmission line even if the storage's connection module becomes faulty in the SAN configuration. This prevents degradation in server processing performance caused by the server waiting for response from the transmission line containing the faulty area.

Note that it is possible to provide the management device's functions discussed above as programs and install these programs, for example, onto the server 21 for execution in this server. In this case, the management device 13 is not required.

A server and a storage are connected by a plurality of transmission lines, and if a failure occurs which makes a transmission line unavailable during execution of an application program in the server when a plurality of transmission lines are used, the server is automatically caused to stop using the transmission line which becomes unavailable due to the failure.

This makes it possible to avoid application program's wait time caused by the server accessing the transmission line containing the faulty area, thus preventing degradation in server performance. Moreover, this allows speedy failure analysis and replacement of faulty parts in terms of system administration, thus enhancing the system administration efficiency.

When the transmission line, which was used by the server to execute the application program prior to the failure, is restored at the completion of parts replacement, the restored transmission line is automatically used by the server, thus taking part of the burden needed for restoration off the system administrator.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A network calculator system comprising:
a server connected to a network;
a storage connected to the network and to the server through a plurality of transmission paths; and
a management device connected to the network for recording a correspondence between the transmission paths and devices included in the transmission paths,
wherein if a device fails, which is included in the transmission path through which the server accesses data stored in the storage, the server or the storage notifies the management device of the faulty device, and said management device judges whether the notified faulty device is included in another transmission path, and if the notified faulty device is included in another transmission path, said management device determines the transmission path through which the server accesses data stored in the storage and also the another transmission path as being unavailable and causes the server to stop using the unavailable transmission paths when the server accesses the storage.

2. A network calculator system according to claim 1 further comprising a fiber channel switch connected to the network, the server and the storage for notifying of a faulty device included in the fiber channel switch,
wherein the fiber channel switch is included in the transmission paths.

3. A network calculator system comprising:
a server connected to a network for managing its own device information and returning the device information in reply to a request;
a storage connected to the network and to the server by a plurality of transmission paths for managing its own device information and returning the device information in reply to a request; and
a management device connected to the network for managing device information on the server and the storage,
wherein said management device records a correspondence between transmission paths through which the server accesses data stored in the storage and devices included in the transmission paths, and makes the request to the server and the storage for the device information on a regular basis, and judges from the returned device information whether there is any faulty device, and determines transmission paths which include the faulty device as being unavailable, and causes the server, which accesses through the transmission paths when an application program is executed, to stop using the unavailable transmission paths.

4. A network calculator system according to claim 3 further comprising a fiber channel switch connected to the network, the server and the storage for managing its own device information and returning the device information in reply to a request,
wherein the management device makes the request to the fiber channel switch for the device information on a regular basis.

5. A network calculator system comprising:
a server connected to a network;
a storage connected to the network and to the server by a plurality of transmission paths; and
a management device connected to the network for recording a correspondence between transmission paths and devices included in the transmission paths,
wherein if a device is restored, which is included in the transmission path through which the server accesses data stored in the storage, the server or the storage notifies the management device of the restored device, and said management device judges whether the restored device is included in another transmission path, and if the restored device is included in another transmission path, said management device determines the transmission path through which the server accesses data stored in the storage and also the another transmission path as being available, and causes the server, which accesses through the transmission paths when an application program is executed, to start using the transmission paths.

6. A network calculator system according to claim 5 further comprising a fiber channel switch connected to the network, the server and the storage for notifying of restoration of a faulty device included in the fiber channel switch,
wherein the transmission paths include the fiber channel switch.

7. A network calculator system comprising:
a server connected to a network for managing its own device information and returning the device information in reply to a request;
a storage connected to the network and to the server by a plurality of transmission paths for managing its own device information, and returning the device information in reply to a request; and
a management device connected to the network for managing device information on the server and the storage,
wherein said management device records a correspondence between transmission paths through which the server accesses data stored in the storage and devices included in the transmission paths, and makes the request to the server and the storage for the device information on a regular basis, and stores the returned device information, and judges whether a device status changes from abnormal condition to normal condition, and if a device status changes from abnormal condition to normal condition, said management device determines transmission paths as being available, which include the device of which status changes from abnormal condition to normal condition, and causes the server, which accesses through the transmission paths when an application program is executed, to start using the transmission paths.

8. A network calculator system according to claim 7 further comprising a fiber channel switch connected to the network, the server and the storage for managing its own device information and returning the device information in reply to a request,
wherein the management device makes the request to the fiber channel switch for the device information on a regular basis.

9. A management method in a management device, provided in a network calculator system having a server and a storage, wherein each of which is connected to a network, wherein the server and the storage are connected to each other by a plurality of the transmission paths, and wherein each of which notifies of a faulty device included in the transmission paths through which the server accesses data stored in the storage, said management method comprising:
managing the server and storage device information;
receiving a notification of a faulty device from the server or storage;
recording a correspondence between transmission paths through which the server accesses data stored in the storage and devices included in the transmission paths;
determining a transmission path as being unavailable if the notified faulty device is included in the transmission paths; and
causing the server, which accesses through the unavailable transmission path, to stop using that transmission path when the server accesses the storage.

10. A management method in a management device, provided in a network calculator system having a server and a storage, wherein each of which is connected to a network, wherein the server and the storage are connected to each other by a plurality of the transmission paths, and wherein each of which notifies of a faulty device included in the transmission paths through which the server accesses data stored in the storage, said management method comprising:
managing the server and storage device information;
receiving a notification of a failure device from the server or storage;
recording a correspondence between transmission paths through which the server accesses data stored in the storage and devices included by the transmission paths;
requesting for the device information to the server and the storage on a regular basis;
storing the returned device information;
judging whether a device status changes from abnormal condition to normal condition;
determining a transmission path as being available if the transmission path include the device of which status changes from abnormal condition to normal condition; and
causing the server, which accesses through the transmission paths when an application program is executed, to start using the transmission paths.
